(19) United States
(12) Patent Application Publication
(10) Pub. No.: US 2015/0199954 A1
(43) Pub. Date: Jul. 16, 2015

(54) METHOD, APPARATUS AND STORAGE MEDIUM FOR SOUND MASKING

(71) Applicant: Yamaha Corporation, Hamamatsu-shi (JP)

(72) Inventors: Satoshi UKAI, Hamamatsu-shi (JP); Takashi YAMAKAWA, Hamamatsu-shi (JP)

(21) Appl. No.: 14/668,918

(22) Filed: Mar. 25, 2015

Related U.S. Application Data
(63) Continuation of application No. PCT/JP2013/075806, filed on Sep. 25, 2013.

(30) Foreign Application Priority Data
Sep. 25, 2012 (JP) 2012-210957

(51) Int. Cl. G10K 11/175

(52) U.S. Cl. CPC G10K 11/175

(57) ABSTRACT

A first calculating portion calculates a model sound index value which is an index value of the maximum value of power for each frequency band of the model sound which is a model of a target sound. A second calculating portion calculates a source sound index value which is an index value of power for each frequency band with respect to each of frames extracted by a predetermined time length from a source sound signal. A third calculating portion calculates a performance index value indicating performance of masking the model sound by a sound represented by a block formed of a predetermined number of consecutive frames extracted from the source sound signal, by using the model sound index value and the source sound index value. A frame selecting portion determines a block to be used for generating the masker sound based on the performance index value.

### TECHNICAL FIELD

The present invention relates to a technology called sound masking for preventing voice produced by a speaker from being overheard by others.

### BACKGROUND ART

There are cases where it is not desirable that a conversation conducted in a public location is heard by others. Accordingly, there is a technology called sound masking (hereinafter will simply be referred to as “masking”) which emits sounds to a public location to make it difficult for others to hear the conversation. In the present application, a sound which masks will be referred to as a masker sound, a signal representing the masker sound as a masker sound signal, a sound to be masked as a target sound, and a signal representing the target sound as a target sound signal. Further, a sound signal to be used as a material in generation of the masker sound signal will be referred to as a source sound signal.

For example, it is known that when a sound having a low correlation of frequency characteristics with the target sound, like white noise, is used as the masker sound, an equivalent masking effect can be obtained at a small sound pressure level as compared to the case where a sound having a high correlation of frequency characteristics with the target sound is used as the masker sound. Thus, there has been proposed a technology to generate a masker sound signal by using a sound signal representing a human voice in order to mask the human voice.

For example, PTL1 proposes a technology to execute normalizing process which makes time fluctuations in volume of a masker sound signal be within a predetermined range in the process of generating the masker sound signal by changing the order of an arrangement of sound signals representing human voices. The technology of PTL1 enables to obtain a masker sound which causes a listener to feel less unnatural accent than a masker sound not subjected to the normalizing processing.

### CITATION LIST

### Patent Literature

{PTL1} JP 2011-154140 A

### SUMMARY OF INVENTION

### Technical Problem

A sound signal representing a human voice largely changes in amplitude as compared to, for example, the white noise. Therefore, when a masker sound is emitted according to a masker sound signal generated by using a sound signal representing a human voice as a source sound signal, unless any special measure is taken, there may occur a period in which the sound volume level of the masker sound does not reach a sound volume level needed for masking the target sound (hereinafter, this period will be referred to as a “gap period”). In the gap period, it is possible that the conversation is overheard by others, and thus the masker sound is desired to have less such gap periods.

As a method to generate a masker sound having less gap periods, there is a method to add plural source sound signals representing a human voice. In a masker sound signal in which the plural source sound signals are added, the gap period is less likely to occur unless gap periods of all source sound signals contingently overlap at the same timing. Therefore, by increasing the number of the source sound signals to be added to a certain degree or more, it is possible to generate a masker sound signal which substantially has no gap period.

When the masker sound signal is generated by adding the plural source sound signals, the more the number of source sound signals to be added is increased, the more the probability of occurrence of the gap period in the masker sound signal lowers, and simultaneously, the more the unsteadiness of the masker sound signal decreases. When the unsteadiness of the masker sound signal decreases, a target sound having a large unsteadiness, such as a voice, can be easily heard through the masker sound, and thus the sound pressure level needed for obtaining an equivalent masking effect with respect to the target sound increases. When the sound pressure level of the masker sound is large, it is unpleasant for a listener to hear. Thus, from the viewpoint of comfort of the listener, the number of source sound signals to be added in generation of the masker sound signal is desired to be small.

Further, as another method to generate a masker sound signal having less gap periods, there is a method to divide a source sound signal representing a human voice into segments with a shorter time length than a syllable length, select segments where power is in a constant range, and the order of these selected segments are replaced to couple them, to thereby generate the masker sound signal. In this case, the shorter the length of a segment is, the higher the probability for an average sound pressure level of the masker sound signal to be a constant value or more within a predetermined time, enabling to obtain a masker sound signal having less gap periods.

The sound represented by the masker sound signal, which is generated by dividing the source sound signal into segments with a short time equal to or less than a syllable length and coupling them in a replaced order, becomes a sound similar to sounds in which syllables change continuously in a shorter time than in a normal voice. Such sounds are heard by a listener like a voice at high speech rate and are unpleasant to hear, and thus not desirable from the viewpoint of comfort of the listener.

In view of such situations, it is an object of the present invention to provide a masker sound having a low probability of occurrence of the gap period without impairing the comfort of the listener as compared to the cases of conventional arts.

### Solution to Problem

To resolve the above problem, the invention provides an apparatus for generating a masker sound signal, including: a model sound signal obtaining portion configured to obtain a model sound signal corresponding to a sound to be masked; a model sound index value calculating portion configured to calculate an index value of magnitude of the model sound signal; a source sound signal obtaining portion configured to obtain a source sound signal for generating a masker sound signal representing a sound which masks; a source sound index value calculating portion configured to divide the source sound signal into plural frames having a predetermined time length and calculate an index value of magnitude of a sound signal in each of the plural frames; a masking performance calculating portion configured to calculate, by using the index value calculated by the model sound index value calculating portion and the index value calculated by the source sound index value calculating portion, an index value of performance of masking by a sound represented by one or more frames of the source sound signal; a frame selecting portion configured to select plural frames from among the plural frames of the source sound signal based on the index value calculated by the masking performance calculating portion; and a frame coupling portion configured to couple the plural frames selected by the frame selecting portion on a time axis, to thereby generate the masker sound signal.

The above apparatus for generating a masker sound signal may be configured such that the model sound index value calculating portion divides the model sound signal into plural frames having a predetermined time length, calculates an index value of magnitude of a sound signal in each of the plural frames, and takes a maximum value among the calculated index values as the index value of magnitude of the model sound signal.

Further, the above apparatus for generating a masker sound signal may be configured such that the model sound index value calculating portion calculates the index value of magnitude of the model sound signal for each frequency band of two or more frequency bands, the source sound index value calculating portion calculates the index value of magnitude of the sound signal in each of the plural frames for each frequency band of the two or more frequency bands, and the masking performance calculating portion calculates, for each frequency band of the two or more frequency bands, the index value of performance for the frequency band by using the index value calculated by the model sound index value calculating portion and the index value calculated by the source sound index value calculating portion.

Further, the above apparatus for generating a masker sound signal may be configured such that the masking performance calculating portion calculates, for each frequency band of the two or more frequency bands, the index value of performance so as not to exceed a predetermined threshold.

Further, the above apparatus for generating a masker sound signal may be configured such that an adding portion configured to add the plural frames selected from among plural frames of the source sound signal to generate an added frame is provided, and the masking performance calculating portion calculates the index value of performance indicating a performance of masking by a sound represented by the added frame generated by the adding portion.

Further, the above apparatus for generating a masker sound signal may be configured such that an adjusting portion configured to increase or decrease a sound volume level of one or more frames among the plural frames of the source sound signal is provided, and the masking performance calculating portion calculates the index value of performance indicating a performance of masking by a sound represented by a frame whose sound volume level is increased or decreased by the adjusting portion.

Further, the above apparatus for generating a masker sound signal may be configured such that a sound emitting portion configured to emit a sound according to the masker sound signal generated by the frame coupling portion is provided.

Further, the invention provides a method for generating a masker sound signal, including: obtaining a model sound signal corresponding to a sound to be masked; calculating an index value of magnitude of the model sound signal; obtaining a source sound signal for generating a masker sound signal representing a sound which masks; dividing the source sound signal into plural frames having a predetermined time length and calculating an index value of magnitude of a sound signal in each of the plural frames; calculating, by using the index value of magnitude of the model sound signal and the index value of magnitude of a sound signal in each of the plural frames of the source sound signal, an index value of performance of masking by a sound represented by one or more frames of the source sound signal; selecting plural frames from among the plural frames of the source sound signal based on the index value of performance; and coupling the selected plural frames on a time axis, to thereby generate the masker sound signal.

Further, the invention provides an apparatus for emitting a masker sound signal, including a sound emitting portion configured to emit a sound according to the masker sound signal generated by the above method for generating a masker sound signal.

Further, the invention provides a non-transitory machine-readable storage medium containing program instructions executable by a computer for generating a masker sound signal, the program instructions enabling the computer to perform: obtaining a model sound signal corresponding to a sound to be masked; calculating an index value of magnitude of the model sound signal; obtaining a source sound signal for generating a masker sound signal representing a sound which masks; dividing the source sound signal into plural frames having a predetermined time length and calculating an index value of magnitude of a sound signal in each of the plural frames; calculating, by using the index value of magnitude of the model sound signal and the index value of magnitude of a sound signal in each of the plural frames of the source sound signal, an index value of performance of masking by a sound represented by one or more frames of the source sound signal; selecting plural frames from among the plural frames of the source sound signal based on the index value of performance; and coupling the selected plural frames on a time axis, to thereby generate the masker sound signal.

### Advantageous Effects of Invention

According to the present invention, plural frames obtained by dividing a source sound signal by a predetermined time length are coupled on a time axis to generate a masker sound signal. At this time, by using an index value of magnitude of a model sound signal and an index value of magnitude of a frame of the source sound signal, an index value indicating a performance of masking a model sound by a sound represented by the frame is calculated, and a frame determined based on the index value of performance is used for generating the masker sound signal. Consequently, a masker sound excellent in masking performance as compared to the cases of conventional arts is provided.

### BRIEF DESCRIPTION OF DRAWINGS

FIG. 1 is a view schematically illustrating a situation where a masker sound emitting apparatus according to a first embodiment of the present invention is used.

FIG. 2 is a diagram schematically illustrating a hardware configuration of the masker sound emitting apparatus according to the first embodiment of the present invention.

FIG. 3 is a diagram schematically illustrating a functional configuration of the masker sound emitting apparatus according to the first embodiment of the present invention.

FIG. 4 is a diagram illustrating the overview of a process flow when a masker sound signal generating apparatus according to the first embodiment of the present invention generates a masker sound signal.

FIG. 5 is a diagram schematically illustrating a functional configuration of the masker sound signal generating apparatus according to the first embodiment of the present invention.

FIG. 6 is a flowchart illustrating a process of calculating a model sound index value by the masker sound signal generating apparatus according to the first embodiment of the present invention.

FIG. 7 is a diagram illustrating how the masker sound signal generating apparatus according to the first embodiment of the present invention generates frames from a model sound signal

FIG. 8A is a diagram schematically illustrating power spectra generated by the masker sound signal generating apparatus according to the first embodiment of the present invention.

FIG. 8B is a diagram schematically illustrating index values generated by the masker sound signal generating apparatus according to the first embodiment of the present invention.

FIG. 8C is a diagram schematically illustrating model sound index values generated by the masker sound signal generating apparatus according to the first embodiment of the present invention.

FIG. 9 is a flowchart illustrating a process of calculating a source sound index value by the masker sound signal generating apparatus according to the first embodiment of the present invention.

FIG. 10 is a flowchart illustrating a process of determining an employed block by the masker sound signal generating apparatus according to the first embodiment of the present invention.

FIG. 11 is a diagram schematically illustrating the concept of a performance index value calculated by the masker sound signal generating apparatus according to the first embodiment of the present invention.

FIG. 12 is a flowchart illustrating a process of determining an employed block by the masker sound signal generating apparatus according to the first embodiment of the present invention.

FIG. 13 is a diagram schematically illustrating the concept of a performance index value calculated by the masker sound signal generating apparatus according to the first embodiment of the present invention.

FIG. 14 is a flowchart illustrating a process of determining an employed block by the masker sound signal generating apparatus according to the first embodiment of the present invention.

FIG. 15 is a flowchart illustrating a process of determining an employed block by the masker sound signal generating apparatus according to the first embodiment of the present invention.

FIG. 16 is a flowchart illustrating a process of generating the masker sound signal by the masker sound signal generating apparatus according to the first embodiment of the present invention.

FIG. 17 is a view schematically illustrating a situation where a masker sound emitting apparatus according to a second embodiment of the present invention is used.

FIG. 18 is a diagram schematically illustrating a functional configuration of the masker sound emitting apparatus according to the second embodiment of the present invention.

FIG. 19 is a diagram for explaining which parts of a pickup sound signal are used as a model sound signal and source sound signals when the masker sound emitting apparatus according to the second embodiment of the present invention generates a masker sound signal.

FIG. 20 is a view schematically illustrating a situation where a masker sound signal generating apparatus according to a third embodiment of the present invention is used.

FIG. 21 is a diagram schematically illustrating a functional configuration of the masker sound signal generating apparatus according to the third embodiment of the present invention.

### DESCRIPTION OF EMBODIMENTS

### First Embodiment

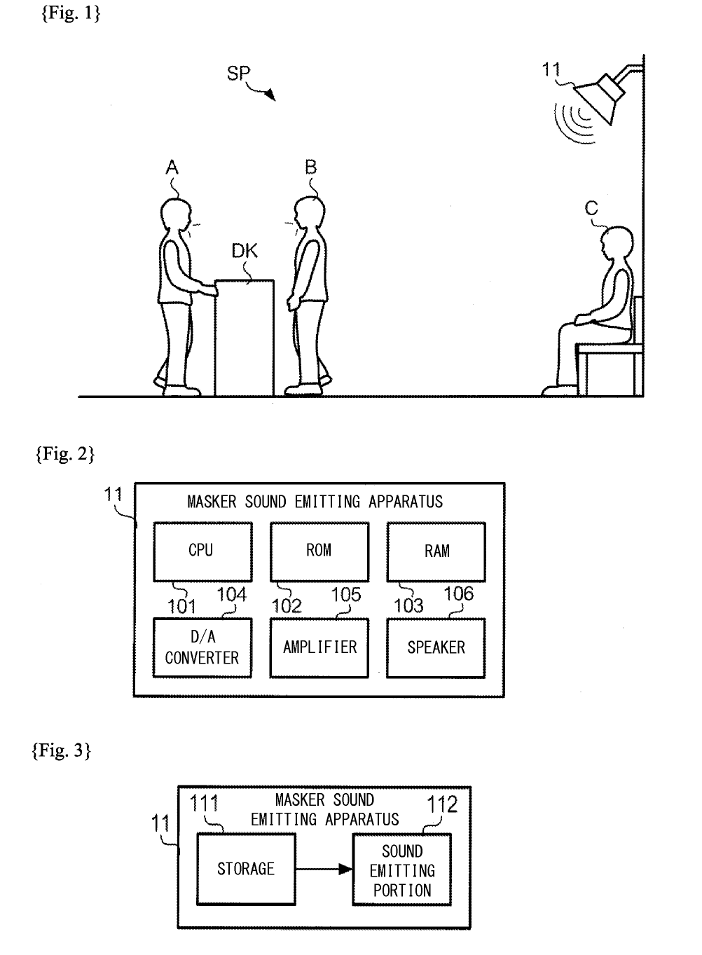

FIG. 1 is a view schematically illustrating a situation where a masker sound emitting apparatus 11 according to a first embodiment of the present invention is used. A sound space SP is, for example, a lobby of a medical institution, where a medical staff A and a patient B are making a conversation across a reception desk DK. There is a visitor C irrelevant to the patent B in the sound space SP. The conversation between the medical staff A and the patent B may include personal information which should be kept confidential, and thus it is not desired that the conversation is overheard by the visitor C. In order to prevent such overhearing of conversation, the masker sound emitting apparatus 11 which emits a masker sound is placed in the sound space SR

FIG. 2 is a diagram schematically illustrating a hardware configuration of the masker sound emitting apparatus 11. The masker sound emitting apparatus 11 has: a CPU 101 performing various types of control process; a ROM 102 storing a program instructing a process to the CPU 101, a masker sound signal and the like; a RAM 103 used by the CPU 101 as a working area to temporarily store various data; a D/A converter 104 converting the masker sound signal stored as digital data in the ROM 102 into an analog signal; an amplifier 105 amplifying the masker sound signal converted into an analog signal to a speaker driving level; and a speaker 106 emitting a masker sound according to the masker sound signal amplified up to a speaker driving level.

FIG. 3 is a diagram schematically illustrating a functional configuration of the masker sound emitting apparatus 11. Specifically, the hardware configuration of the masker sound emitting apparatus 11 illustrated in FIG. 2 functions as an apparatus having components illustrated in FIG. 3 as a result of operating under control of the CPU 101 which operates by following the program stored in the ROM 102. Specifically, the masker sound emitting apparatus 11 has a storage 111 configured to store a masker sound signal and a sound emitting portion 112 configured to emit a masker sound according to the masker sound signal stored in the storage 111, as its functional components. The masker sound signal stored in the storage 111 of the masker sound emitting apparatus 11 is generated by a masker sound signal generating apparatus 12 according to this embodiment.

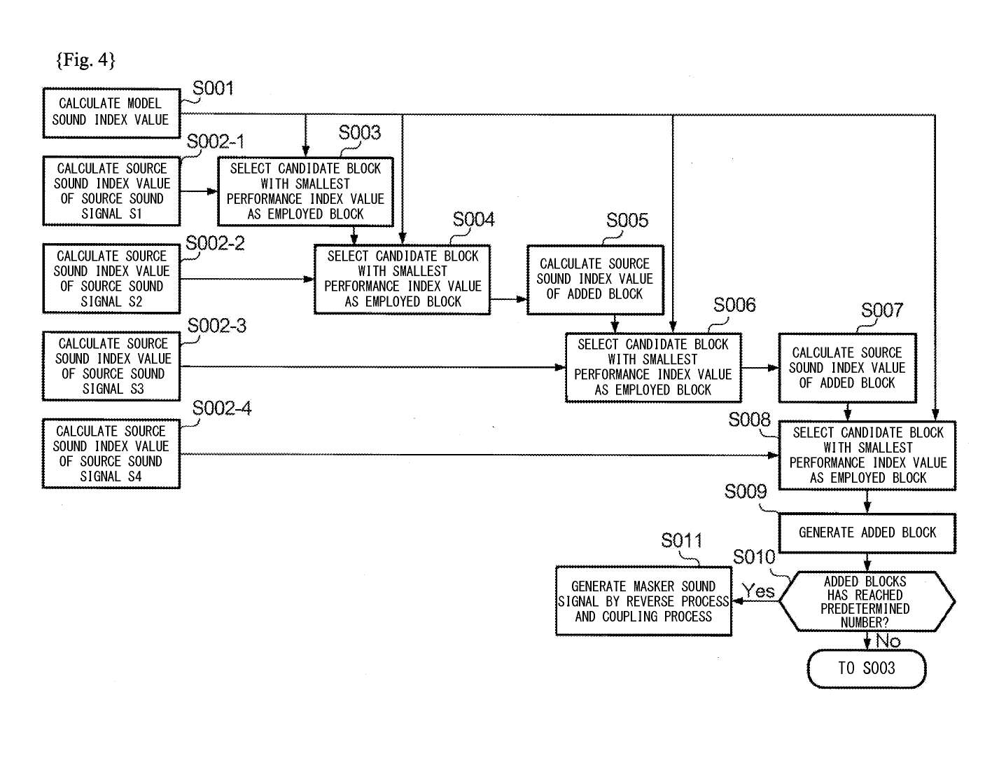

FIG. 4 is a diagram illustrating the overview of a process flow when the masker sound signal stored in the masker sound emitting apparatus 11 is generated by the masker sound signal generating apparatus 12. First, the masker sound signal generating apparatus 12 calculates a model sound index value which is an index value of magnitude of a model sound signal M representing a model sound as the sound corresponding to a target sound (step S001). The model sound is a sound assumed as a target sound and is used when the masker sound signal generating apparatus 12 generates the masker sound signal, so as to evaluate the performance of masking the target sound by the masker sound represented by the generated masker sound signal.

Note that although specific contents of the model sound signal M representing the model sound will be described later, in this embodiment, a sound of reading a text by each of plural persons with different attributes, which is picked up and stored in advance, is used as the model sound signal M. On the other hand, in a second embodiment and a third embodiment, a sound (target sound) of actual conversations in the sound space SP, which is picked up in real time when the masker sound signal is generated, is used as the model sound signal M.

Next, for each of source sound signals S1 to S4 as four different source sound signals, the masker sound signal generating apparatus 12 calculates a source sound index value as an index value of magnitude of each of plural frames, which are obtained by dividing the source sound signal by a predetermined time length (for example, 170 ms) (steps S002-1 to S002-4). Note that the steps S002-1 to S002-4 as a process of calculating the source sound index value for each of the source sound signals S1 to S4 are all the same, and thus they are simply referred to as step S002 when they are not distinguished. Further, when each of the source sound signals S1 to S4 is not to be distinguished, it is simply referred to as a source sound signal S.

Subsequently, the masker sound signal generating apparatus 12, assuming a predetermined number (eight for example) of consecutive frames from the source sound signal S1 as one block, sequentially retrieves plural blocks of candidates used for generating the masker sound signal while shifting the frames one by one from the head (hereinafter, a block retrieved thus from the source sound signal S as a candidate to be used for generating the masker sound signal will be referred to as a “candidate block”). Then, for each of these sequentially retrieved candidate blocks, the source sound index value is calculated for each of frames contained in the candidate block. Next, by using the calculated source sound index value and the model sound index value, a performance index value is calculated according to a predetermined calculation formula, which will be described later. Here, the performance index value is an index value of performance of masking the model sound (sound used as the target sound when the masker sound signal is generated) by the sound represented by a sound signal generated by using the candidate block, and specifically is an index value of difference in power between the model sound and the source sound over the entire range of a frequency band of voice. Therefore, regarding the performance index value in this embodiment, the smaller the numeric value thereof is, the more the characteristics of power of the source sound are close to characteristics of power of the model sound, and the higher the performance of masking it indicates. The masker sound signal generating apparatus 12 determines one candidate block with the smallest performance index value as a block to be employed for generating the masker sound signal from the source sound signal S1 (hereinafter, the block determined as a block to be employed for generating the masker sound signal will be referred to as an “employed block”) (step S003).

Subsequently, the masker sound signal generating apparatus 12 performs, for the source sound signal S2, a process similar to step S003 performed for the source sound signal S1 (step S004). Specifically, eight consecutive frames are sequentially retrieved from the source sound signal S2 as plural candidate blocks while shifting the frames one by one from the head. For each of the candidate blocks, source sound index values of the respective frames contained in the candidate block are calculated. Next, the performance index value is calculated according to the predetermined calculation formula, which will be described later, using the source sound index values of the respective frames contained in the calculated candidate block, the source sound index values of the respective frames contained in the employed block from the source sound signal S2 determined in step S003, and the model sound index value. The masker sound signal generating apparatus 12 determines one candidate block with the smallest calculated performance index value as the employed block from the source sound signal S2.

Subsequently, the masker sound signal generating apparatus 12 adds the employed block from the source sound signal S1 determined in step S003 and the employed block from the source sound signal S2 determined in step S004 to generate an added block (hereinafter referred to as an “added block of two sources”), and calculates an index value of magnitude for each of the frames contained in this added block of two sources (step S005). Hereinafter, the index value of magnitude of a frame contained in the added block will also be referred to as a source sound index value.

Subsequently, the masker sound signal generating apparatus 12 performs, for the source sound signal S3, a process similar to step S004 performed for the source sound signal S2 (step S006). Specifically, eight consecutive frames are sequentially retrieved from the source sound signal S3 as plural candidate blocks while shifting the frames one by one from the head. For each of the candidate blocks, source sound index values of respective frames contained in the candidate block are calculated. Next, the performance index value is calculated according to the predetermined calculation formula, which will be described later, using the source sound index values of the respective frames contained in the calculated candidate blocks, the source sound index values of the respective frames contained in the added block of two sources generated in step S005, and the model sound index value. The masker sound signal generating apparatus 12 determines the candidate block with the smallest calculated performance index value as the employed block from the source sound signal S3.

Subsequently, the masker sound signal generating apparatus 12 adds the added block of two sources generated in step S005 and the employed block from the source sound signal S3 determined in step S006 to generate a new added block (hereinafter referred to as an “added block of three sources”), and calculates a source sound index value for each of the frames contained in this added block of three sources (step S007).

Subsequently, the masker sound signal generating apparatus 12 performs, for the source sound signal S4, a process similar to step S006 performed for the source sound signal S3 (step S008). Specifically, eight consecutive frames are sequentially retrieved from the source sound signal S4 as plural candidate blocks while shifting the frames one by one from the head. For each of the candidate blocks, respective source sound index values of frames contained in the candidate block are calculated. Next, the performance index value is calculated according to the predetermined calculation formula, which will be described later, using the respective source sound index values of the frames contained in the calculated candidate blocks, the respective source sound index values of the frames contained in the added block of three sources generated in step S007, and the model sound index value. The masker sound signal generating apparatus 12 determines the candidate block with the smallest calculated performance index value as the employed block from the source sound signal S4.

Subsequently, the masker sound signal generating apparatus 12 adds the added block of three sources generated in step S007 and the employed block from the source sound signal S4 determined in step S008 to generate a new added block (hereinafter referred to as an “added block of four sources”) (step S009).

Subsequently, the masker sound signal generating apparatus 12 judges whether the number of added blocks of four sources generated in step S009 in the past has reached a predetermined number or not (step S010). When the number of added blocks of four sources has not reached the predetermined number (for example, 126) (No in step S010), the masker sound signal generating apparatus 12 returns the process to step S003, and repeats the process of step S003 and so on.

At that time, the masker sound signal generating apparatus 12 excludes a candidate block containing the frames contained in the block determined as an employed block for a certain period in the past from choices of employed blocks in steps S003, S004, S006, and S008. Therefore, in these steps, a candidate block determined as an employed block in the certain period in the past will not be redundantly determined as the employed block again.

When the number of added blocks of four sources generated in step S009 in the past has reached the predetermined number (Yes in step S010), the masker sound signal generating apparatus 12 performs a reverse process on each of the predetermined number of added blocks of four sources, and arranges and couples in a time axis direction the predetermined number of added blocks of four sources which have been subjected to the reverse process (step S011). The reverse process in this embodiment is a process to rearrange sample data representing sound signals contained in the added blocks of four sources in a reverse order in the time axis direction. The sound signal generated by the process of step S011 is the masker sound signal used in the masker sound emitting apparatus 11.

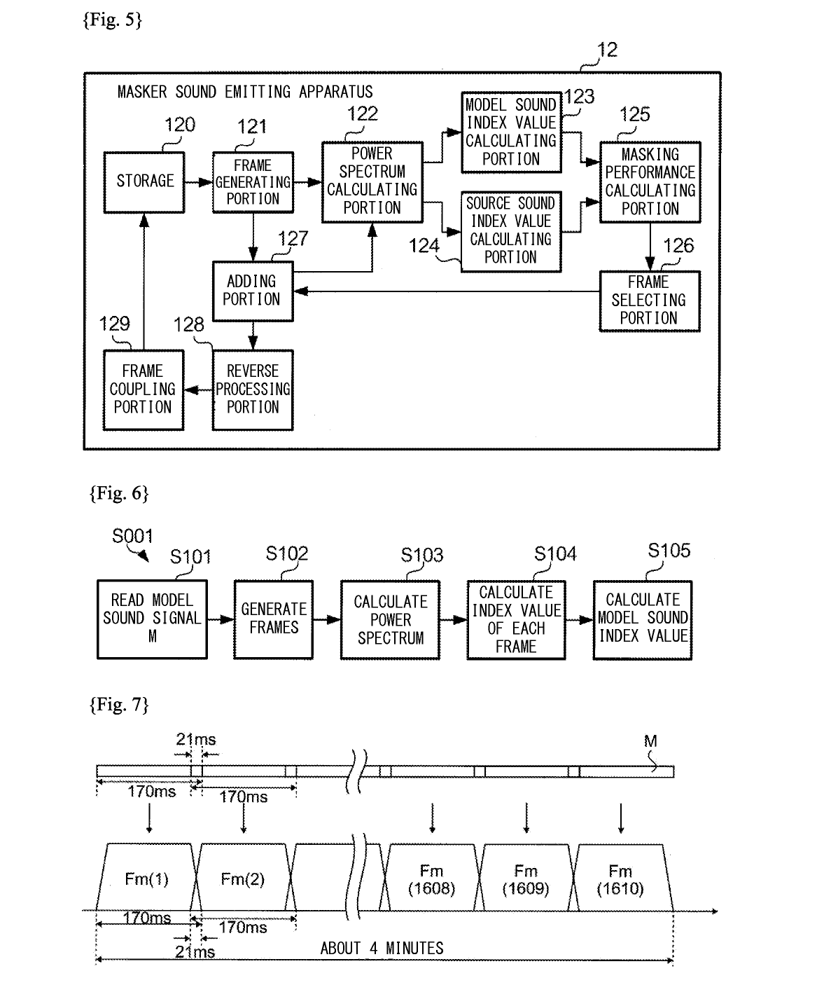

Next, a functional configuration of the masker sound signal generating apparatus 12 will be described. FIG. 5 is a diagram schematically illustrating the functional configuration of the masker sound signal generating apparatus 12. In this embodiment, the masker sound signal generating apparatus 12 is realized by a general computer executing a process following a program according to this embodiment.

The masker sound signal generating apparatus 12 has a storage 120 configured to store the model sound signal M and the source sound signal S, a frame generating portion 121 configured to divide the model sound signal M and the source sound signal S by a predetermined time length (for example, 170 ms) to generate plural frames, a power spectrum calculating portion 122 configured to calculate a power spectrum of sound represented by each frame, a model sound index value calculating portion 123 configured to calculate the model sound index value, and a source sound index value calculating portion 124 configured to calculate the source sound index value. Note that the model sound index value calculating portion 123, the frame generating portion 121 and the power spectrum calculating portion 122 constitute a model sound index value calculating portion of the claims of the present application, and the source sound index value calculating portion 124, the frame generating portion 121 and the power spectrum calculating portion 122 constitute a source sound index value calculating portion of the claims of the present application.

Moreover, the masker sound signal generating apparatus 12 has a masking performance calculating portion 125 configured to calculate the performance index value from the model sound index value and the source sound index value, a frame selecting portion 126 configured to select the frames to be used for generating the source sound signal by determining the employed block from the candidate blocks, an adding portion 127 configured to add the employed blocks determined from the respective source sound signals S1 to S4 to generate the added block, a reverse processing portion 128 configured to perform the reverse process on each of the added blocks of four sources, and a frame coupling portion 129 arranging in the time axis direction the plural added blocks of four sources on which the reverse process has been performed, so as to couple the blocks.

Hereinafter, details of processing to generate the masker sound signal by the masker sound signal generating apparatus 12 will be described below.

(A Process to Calculate the Model Sound Index Value)

FIG. 6 is a flowchart illustrating details of the process of calculating the model sound index value by the masker sound signal generating apparatus 12 (step S001 of FIG. 4). When the model sound index value is calculated, first, the frame generating portion 121 reads the model sound signal M from the storage 120 (step S101).

In this embodiment, as the model sound signal M, a signal obtained by arranging the four source sound signals S1 to S4 in the time axis direction in the order of source sound signals S1, S2, S3, S4 and coupling them to one is used. The source sound signals S1 to S4 are, for example, sound signals representing voices of reading a standard Japanese text which covers vowels and consonants substantially evenly by persons with different attributes from each other, such as a person with a low voice and a person with a high voice, a male and a female, an adult and a child, and so on. The length of each of the source sound signals S1 to S4 is approximately one minute. Therefore, the length of the model sound signal M is approximately four minutes. Note that, in this embodiment, it is assumed that the masker sound signal generated by the masker sound signal generating apparatus 12 is used in Japan, and sound signals representing voices of reading a Japanese text are used as the source sound signals S1 to S4, but sound signals representing voices of reading a text of any other language than Japanese may be used as the source sound signals S1 to S4 depending on the language of the location where the masker sound signal is used.

Note that as the model sound signal M, a sound signal prepared separately from the source sound signals S1 to S4 may be used instead of the signal obtained by coupling the source sound signals S1 to S4. Also in this case, the model sound signal M is desired to be a sound signal representing a voice of reading a standard Japanese text which covers vowels and consonants substantially evenly by persons with different attributes from each other.

The frame generating portion 121 divides the model sound signal M read from the storage 120 by a predetermined time length to generate plural frames (step S102). Specifically, as illustrated in FIG. 7, the frame generating portion 121 generates the frames by cutting out a sound signal with a time length of 170 ms sequentially from the head of the model sound signal M while providing an overlapping section of 21 ms between the signal and an adjacent frame. Hereinafter, the frame cut out from the model sound signal M will be described as a frame Fₘ(i) (where i is a natural number indicating the number of the frame from the head). Note that the number of frames generated by the frame generating portion 121 is about 1610.

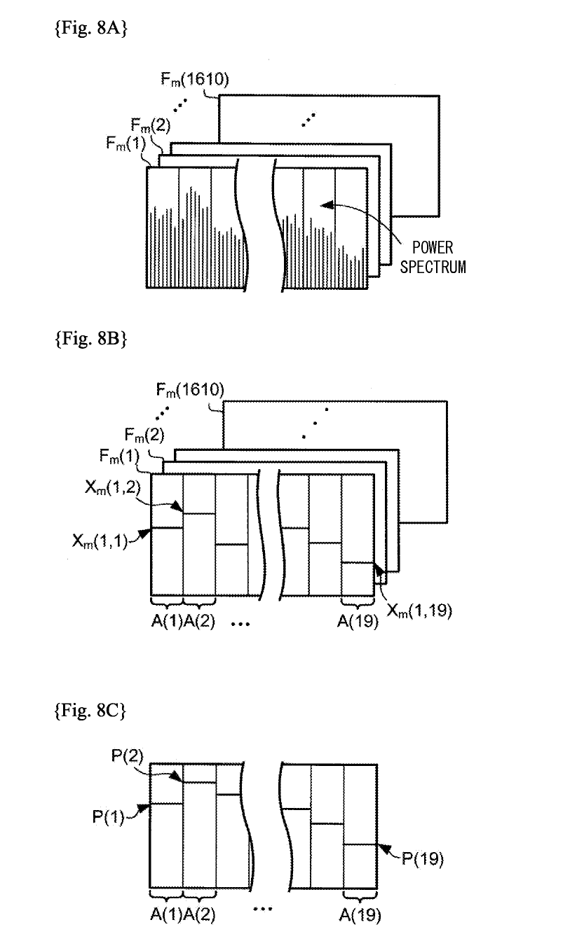

Subsequently, the power spectrum calculating portion 122 calculates the power spectrum of each of the frames Fₘ(i) following a known method (step S103). FIG. 8A to FIG. 8C are diagrams schematically illustrating data to be processed in respective steps of step S103 to step S105. FIG. 8A illustrates the power spectrum calculated by the power spectrum calculating portion 122 in step S103.

Subsequently, the model sound index value calculating portion 123 calculates, for each of the frames Fₘ(i), an average value in every frequency band of the power spectrum as an index value Xₘ(i,f) (where f is a natural number of one of 1 to 19 indicating a frequency band) (step S104). FIG. 8B illustrates the index value Xₘ(i,f) calculated by the model sound index value calculating portion 123. In this embodiment, the model sound index value calculating portion 123 calculates the index value Xₘ(i,f) for each of 19 frequency bands A(f) obtained by dividing a frequency band of voice (for example, 100 Hz to 6300 Hz) by a ⅓ octave band width.

Subsequently, the model sound index value calculating portion 123 calculates, for each of the frequency bands A(f), the maximum value of the index value Xₘ(i,f) in all the frames Fₘ(i) as a model sound index value P(f) as illustrated in FIG. 8C (step S105). Specifically, the model sound index value P(f) is a value represented by following equation 1.

$$\begin{matrix}\{ Math . 1 \} & \\ P ( f ) = {max}_{i} {X}_{m} ( i , f ) \\ ( where {max}_{i} F ( i ) represents a maximum value of a functional value F ( i ) for all i ) & ( Formula 1 )\end{matrix}$$

The model sound index value P(f) is a value which the average value will not exceed in every frame of power spectra of the frequency bands A(f) of the model sound signal M in all the sections in the time axis direction of the model sound signal M. This concludes the details of the process of calculating the model sound index value performed by the masker sound signal generating apparatus 12.

(A Process of Calculating the Source Sound Index Value)

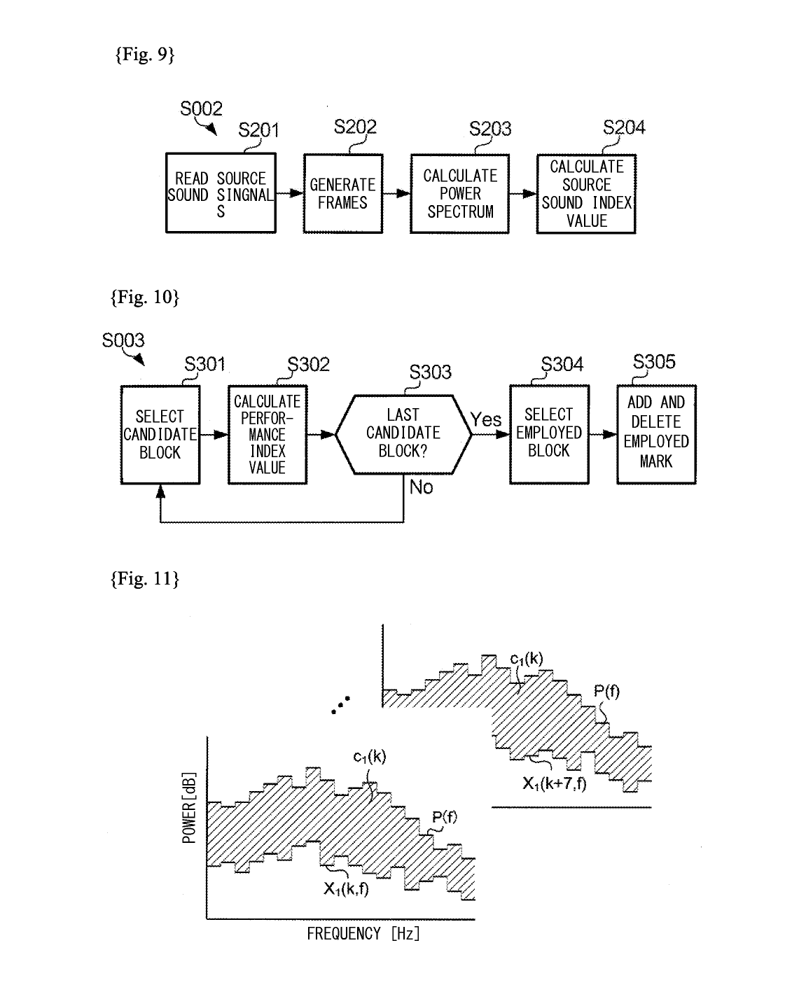

FIG. 9 is a flowchart illustrating details of a process of calculating the source sound index value by the masker sound signal generating apparatus 12 (step S002 of FIG. 4). The process of calculating the source sound index value by the masker sound signal generating apparatus 12 is a process similar to the process of steps S101 to S104 performed when the masker sound signal generating apparatus 12 calculates the model sound index value.

When the source sound index value is calculated, the frame generating portion 121 reads the source sound signal S from the storage 120 (step S201) and generates frames from the source sound signal S (step S202). The method of generating the frames from the source sound signal S by the frame generating portion 121 in step S202 is similar to the method of generating the frames of the model sound signal M in step S102 (see FIG. 7). Note that the source sound signal S has a time length of approximately ¼ of the model sound signal M, and thus the number of frames generated by the frame generating portion 121 from each of the source sound signals S1 to S4 is about 402.

Hereinafter, the frame cut out from the source sound signal S by the frame generating portion 121 will be described as a frame Fₚ(i) (where p is a natural number of any one of 1 to 4 indicating the number corresponding to one of the source sound signals S1 to S4, and i denotes a natural number indicating the number of the frame from the head).

Subsequently, the power spectrum calculating portion 122 calculates a power spectrum of each of the frames Fₚ(i) (step S203). The source sound index value calculating portion 124 calculates, for each of the frames Fₚ(i), an average value in every frequency band of the power spectrum as a source sound index value Xₚ(i,f) (step S204). This concludes the details of the process of calculating the source sound index value performed by the masker sound signal generating apparatus 12.

(A Process of Determining Employed Block from Source Sound Signal S1).

FIG. 10 is a flowchart illustrating details of a process of determining the employed block from the source sound signal S1 by the masker sound signal generating apparatus 12 (step S003 of FIG. 4). When the employed block is determined from the source sound signal S1, first, the masking performance calculating portion 125 sequentially selects, from among the plural frames (about 402 frames) of the source sound signal S1, eight consecutive frames to which an employed mark is not added in step S305, which will be described later, as a candidate block B₁(k) from the head of the source sound signal S1 (step S301). Here, k is a natural number indicating what number of frame the head frame of the candidate block is located at from the head of the source sound signal S, and the subscript “1” indicates that the candidate block is formed of frames selected from the source sound signal S1. For example, in step S301 executed first, the masking performance calculating portion 125 selects the first to eighth frames of the source sound signal S1, namely, F₁(1) to F₁(8) as a candidate block B₁(1).

Subsequently, the masking performance calculating portion 125 calculates a performance index value c₁(k) (where the subscript “1” indicates that the performance index value is a performance index value for the candidate block formed from the source sound signal S1) which is an index value of performance of masking the model sound represented by the model sound signal M by the sound represented by the candidate block B₁(k) selected in step S301 in accordance with following formula 2 (step S302).

$$\begin{matrix}\{ Math . 2 \} & \\ {c}_{1} ( k ) = {\sum }_{f = 1}^{19} {\sum }_{j = 1}^{8} [ 10 {log}_{10} P ( f ) - 10 {log}_{10} {X}_{1} ( k + j - 1 , f ) ] & ( Formula 2 )\end{matrix}$$

Here, j is a natural number of 1 to 8 indicating the number in the candidate block B₁(k) of the frame contained in the candidate block B₁(k), and X₁ (k+j−1,f) is the source sound index value of the f-th frequency band of the j-th frame contained in the candidate block B₁(k). FIG. 11 is a diagram schematically illustrating the concept of the performance index value c₁(k). In FIG. 11, the total value of areas of hatched regions is the performance index value c₁(k). Specifically, the performance index value c₁(k) is a value resulted from summing values obtained by subtracting, in every frequency band, a log-converted value of the source sound index value X₁(k+j−1,f) of each of the eight frames contained in the candidate block B₁(k) from a log-converted value of the model sound index value P(f) of the model sound signal M. Therefore, the performance index value c₁(k) is an index value indicating the magnitude of a cumulative value over the entire frequency band of a difference between the power spectrum of the model sound and the power spectrum of the source sound (candidate block).

The smaller the performance index value c₁(k) is, the more the power spectrum of the source sound (candidate block) is close to the power spectrum of the model sound in each of the frequency bands A(1) to A(19). In other words, the performance index value c₁(k) indicates an approximation degree in distribution of every frequency of the power spectra of the model sound and the source sound (candidate block). Therefore, the smaller the performance index value c₁(k) is, the higher the probability that the degree of the source sound index value X₁(k+j−1,f) of the eight frames contained in the candidate block B₁(k) to be lower than the model sound index value P(f) of the model sound signal M is small. Consequently, the smaller the performance index value c₁(k) is, the smaller the sound pressure level required for masking the model sound by the sound represented by the candidate block B₁(k), and the higher the performance of the sound represented by the candidate block B₁(k) as the masker sound is.

Subsequently, the masking performance calculating portion 125 judges whether or not the candidate block B₁(k) selected in the most recent step S301 is the last candidate block selectable from the source sound signal S1, namely, the candidate block formed of the eight consecutive frames in the end to which the employed mark is not added in the source sound signal S1 (step S303). When the candidate block B₁(k) selected in the most recent step S301 is not the last candidate block selectable from the source sound signal S1 (No in step S303), the masking performance calculating portion 125 returns the process to step S301, and selects eight consecutive frames on the headmost side as a new candidate block B₁(k) from among frames to which the employed mark is not added and which are located closer to the end side of the source sound signal S1 than the eight consecutive frames selected in the most recent step S301. For example, in step S301 executed for the second time, the masking performance calculating portion 125 selects, as the candidate block B₁(2), the second to ninth frames, namely, F₁(2) to F₁(9) of the source sound signal S1.

Subsequently, the masking performance calculating portion 125 repeats the process of steps S302 and S303 for the new candidate block B₁(k) selected in step S301. Thereafter, the masking performance calculating portion 125 repeats the process of steps S301 to S303 until it judges in the judgment of step S303 that the candidate block selected in the most recent step S301 is the last candidate block selectable from the source sound signal S1. Consequently, when there is no frame to which the employed mark is added, the performance index value c₁(k) is calculated for about 395 candidate blocks B₁(k).

When the masking performance calculating portion 125 judges in the judgment of step S303 that the candidate block B₁(k) selected in the most recent step S301 is the last candidate block selectable from the source sound signal S1 (Yes in step S303), the frame selecting portion 126 determines, as an employed block D₁(h), the candidate block B₁(k) corresponding to the minimum value among the calculated performance index values c₁(k) (step S304). Here, h is a natural number indicating what number the employed block is determined at, and the subscript “1” indicates that this employed block is formed of frames of the source sound signal S1.

Subsequently, the frame selecting portion 126 adds the employed mark to the frames contained in the employed block D₁(h) determined in the most recent step S304 among the frames of the source sound signal S and, when the number of frames to which the employed mark is added exceeds a predetermined threshold (for example, 59 which is the number of frames for approximately 10 seconds), deletes the added employed marks sequentially from a frame for which the timing of adding the employed mark is old so that the number of frames to which the employed mark is added becomes less than or equal to the threshold (step S305). The frames to which the employed mark is added in step S305 will be excluded from the frames to be selected for forming the candidate block B₁(k) in the process of step S301 thereafter.

In this manner, in a predetermined period (for example, approximately 10 seconds), the frames to which the employed mark is added are not used for forming the candidate block B₁(k), and thus the same candidate block B₁(k) will not be determined repeatedly as the employed block D₁(h) in the predetermined period. Therefore, the masker sound signal to be generated in a series of processes which will be described continuously below will not be one representing a masker sound which repeats similar waveforms in a predetermined period. If the masker sound signal repeats similar waveforms within a period for about several seconds, the masker sound represented by the masker sound signal becomes a monotonous sound, where it is highly possible that the listener gets used to the masker sound and becomes able to distinguish the masker sound and the target sound, which is undesirable. The masker sound signal generated by the masker sound signal generating apparatus 12 does not cause such a disadvantage. Note that when the aforementioned predetermined period is exceeded, the candidate block B₁(k) which is determined as the employed block D₁ (h) in the past can be determined again as the employed block D₁(h). Therefore, the masker sound signal generated by the masker sound signal generating apparatus 12 may include similar waveforms. However, these mutually similar waveforms are not temporally close to the degree allowing the listener to get used to the sounds thereof, and thus will not cause decrease in performance of the masker sound. In this embodiment, by permitting reuse of candidate blocks within the range in which decrease in performance of the masker sound does not occur as described above, the data size of the source sound signal S required for generating the masker sound signal is suppressed to be small. This concludes the details of the process of determining the employed block from the source sound signal S1 performed by the masker sound signal generating apparatus 12.

(A Process of Determining Employed Block from Source Sound Signal S2)

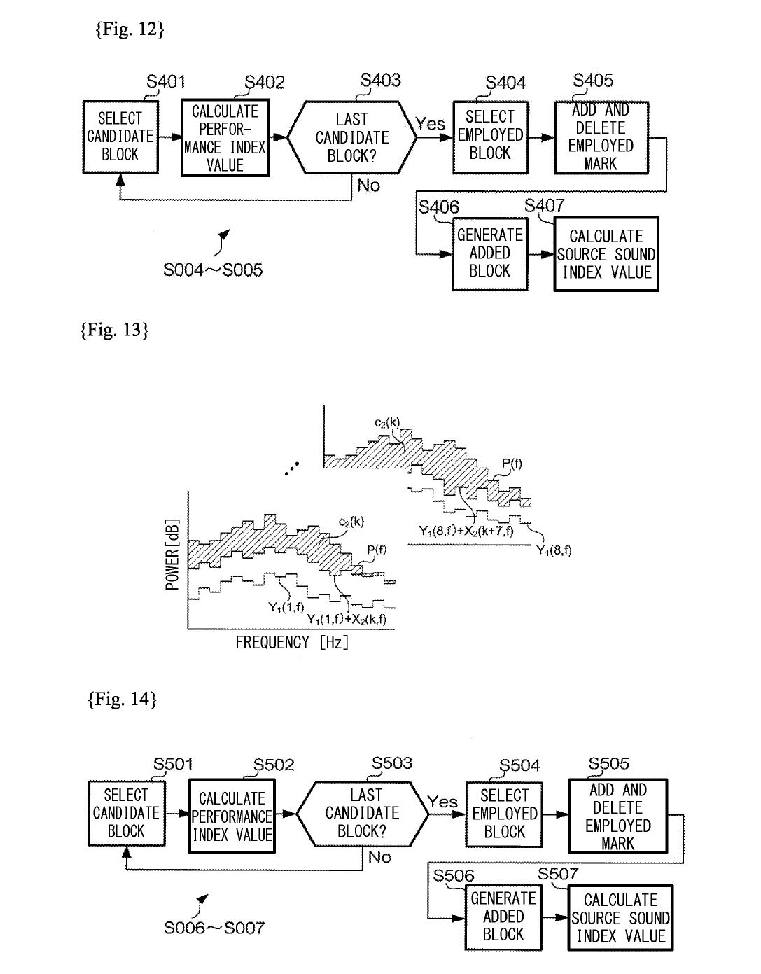

FIG. 12 is a flowchart illustrating details of a process of determining the employed block from the source sound signal S2 by the masker sound signal generating apparatus 12 (steps S004 to S005 of FIG. 4). Steps S401 to S405 in the front half among steps illustrated in FIG. 12 are similar as compared to the steps S301 to S305 of the process of determining the employed block D₁(h) from the source sound signal S1, excluding that the source sound signal S2 is used instead of the source sound signal S1 and that the calculation formula for the performance index value is different.

The following formula 3 is the calculation formula used for calculating the performance index value c₂(k) in step S402 by the masking performance calculating portion 125.

$$\begin{matrix}\{ Math . 3 \} & \\ {c}_{2} ( k ) = {\sum }_{f = 1}^{19} {\sum }_{j = 1}^{8} \{ 10 {log}_{10} P ( f ) - 10 {log}_{10} [ {Y}_{1} ( j , f ) + {X}_{2} ( k + j - 1 , f ) ] \} & ( Formula 3 )\end{matrix}$$

Here, Y₁(j,f) is the source sound index value of each of eight frames contained in the employed block D₁(h) determined in the most recent step S304 by the masking performance calculating portion 125, and one calculated by the source sound index value calculating portion 124 in step S104 (FIG. 6) with respect to the source sound signal S1 is used.

FIG. 13 is a diagram schematically illustrating the concept of the performance index value c₂(k). In FIG. 13, the total value of areas of hatched regions is the performance index value c₂(k). Specifically, the performance index value c₂(k) is a value resulted from summing values obtained by subtracting, in every frequency band, a log-converted value of the source sound index value Y₁(j,f) of each of eight frames contained in the employed block D₁(h) and a log-converted value of the total value of the source sound index value X₁(k+j−1,f) of each of the eight frames contained in the candidate block B₂(k) from a log-converted value of the model sound index value P(f) of the model sound signal M.

The smaller the performance index value c₂(k) is, the higher is the probability that the degree of the source sound index values of the eight frames contained in the added block of two sources obtained by adding the employed block D₁(h) and the candidate block B₂(k) to be lower than the model sound index value P(f) of the model sound signal M is small in each of the frequency bands A(1) to A(19). Therefore, the smaller the performance index value c₂(k) is, the smaller the sound pressure level required for masking the model sound by the sound represented by the added block of two sources is, and the higher the performance of the sound represented by the added block of two sources as the masker sound is.

The frame selecting portion 126 determines the candidate block B₂(k) corresponding to the smallest performance index value c₂(k) as the employed block D₂(h) in step S405, and then the adding portion 127 adds the employed block D₁(h) determined by the frame selecting portion 126 in the most recent step 304 and the employed block D₂(h) determined by the frame selecting portion 126 in the most recent step S404, so as to generate an added block E₂(h) of two sources (step S406). Note that the subscript “2” of the “added block E₂(h)” indicates that this added block is an added block of two sources.

Subsequently, the source sound index value calculating portion 124 calculates, for each of eight frames contained in the added block E₂(h), a source sound index value Y₂(j,f) of the frames (step S407). Note that the subscript “2” of the “source sound index value Y₂(j,f)” indicates that the source sound index value is a source sound index value of frames contained in the added block of two sources. The process performed by the source sound index value calculating portion 124 in step S407 is similar to the process performed in steps S203 to S204 (FIG. 9) of calculating the source sound index value Xₚ(i,f). This concludes the details of the processing of determining the employed block from the source sound signal S2 performed by the masker sound signal generating apparatus 12.

(A Process of Determining Employed Block from Source Sound Signal S3)

FIG. 14 is a flowchart illustrating details of a process of determining the employed block from the source sound signal S3 by the masker sound signal generating apparatus 12 (steps S006 to S007 of FIG. 4). Steps S501 to S507 illustrated in FIG. 14 are similar as compared to steps S401 to S407 of the process of determining the employed block D₂(h) from the source sound signal S2, excluding that the source sound signal S3 is used instead of the source sound signal S2 and that the calculation formula for the performance index value is different.

The following formula 4 is the calculation formula used for calculating the performance index value c₃(k) in step S502 by the masking performance calculating portion 125.

$$\begin{matrix}\{ Math . 4 \} & \\ {c}_{3} ( k ) = {\sum }_{f = 1}^{19} {\sum }_{j = 1}^{8} \{ 10 {log}_{10} P ( f ) - 10 {log}_{10} [ {Y}_{2} ( j , f ) + {X}_{3} ( k + j - 1 , f ) ] \} & ( Formula 4 )\end{matrix}$$

The performance index value c₃(k) is a value resulted from summing values obtained by subtracting, in every frequency band, a log-converted value of the source sound index value Y₂(j,f) of each of eight frames contained in the added block E₂(h) of two sources generated by the adding portion 127 in the most recent step S501 and a log-converted value of the total value of the source sound index value X₃(k+j−1,f) of each of the eight frames contained in the candidate block B₃(k) from a log-converted value of the model sound index value P(f) of the model sound signal M.

The smaller the performance index value c₃(k) is, the higher is the probability that the degree of the source sound index values of the eight frames contained in the added block of three sources obtained by adding the added block E₂(h) of two sources and the candidate block B₃(k) to be lower than the model sound index value P(f) of the model sound signal M is small in each of the frequency bands A(1) to A(19). Therefore, the smaller the performance index value c₃(k) is, the smaller the sound pressure level required for masking the model sound by the sound represented by the added block of three sources is, and the higher the performance of the sound represented by the added block of three sources as the masker sound is. This concludes the details of the process of determining the employed block from the source sound signal S3 performed by the masker sound signal generating apparatus 12.

(A Process of Determining Employed Block from Source Sound Signal S4)

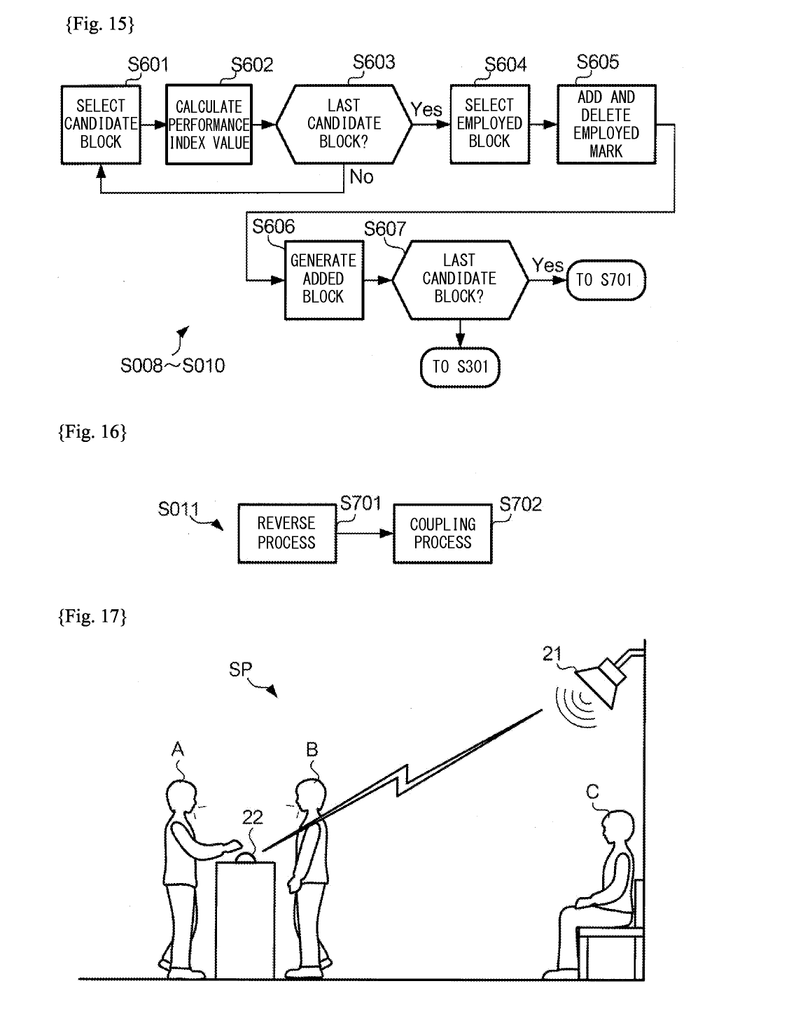

FIG. 15 is a flowchart illustrating details of a process of determining the employed block from the source sound signal S4 by the masker sound signal generating apparatus 12 (steps S008 to S010 of FIG. 4). Steps S601 to S606 among steps illustrated in FIG. 15 are similar as compared to the steps S501 to S506 of the process of determining the employed block D₃(h) from the source sound signal S3, excluding that the source sound signal S4 is used instead of the source sound signal S3 and that the calculation formula for the performance index value is different. Note that process corresponding to step S507 of the process of determining the employed block D₃(h) from the source sound signal S3 (calculation of the performance index value of the added block of three sources) is unnecessary and hence not performed.

The following formula 5 is the calculation formula used for calculating the performance index value c₄(k) in step S602 by the masking performance calculating portion 125.

$$\begin{matrix}\{ Math . 5 \} & \\ {c}_{4} ( k ) = {\sum }_{f = 1}^{19} {\sum }_{j = 1}^{8} \{ 10 {log}_{10} P ( f ) - 10 {log}_{10} [ {Y}_{3} ( j , f ) + {X}_{4} ( k + j - 1 , f ) ] \} & ( Formula 5 )\end{matrix}$$

The performance index value c₄(k) is a value resulted from summing values obtained by subtracting, in every frequency band, a log-converted value of the source sound index value Y₃(j,f) of each of eight frames contained in the added block E₃(h) of three sources generated by the adding portion 127 in the most recent step S601 and a log-converted value of the total value of the source sound index value X₄(k+j−1,f) of each of the eight frames contained in the candidate block B₄(k) from a log-converted value of the model sound index value P(f) of the model sound signal M.

The smaller the performance index value c₄(k) is, the higher is the probability that the degree of the source sound index values of the eight frames contained in the added block of four sources obtained by adding the added block E₃(h) of three sources and the candidate block B₄(k) to be lower than the model sound index value P(f) of the model sound signal M is small in each of the frequency bands A(1) to A(19). Therefore, the smaller the performance index value c₄(k) is, the smaller the sound pressure level required for masking the model sound by the sound represented by the added block of four sources is, and the higher the performance of the sound represented by the added block of four sources as the masker sound is.

The adding portion 127 generates the added block E₄(h) of four sources in step S606, and then judges whether or not the number of added blocks E₄(h) of four sources generated in the past has reached the number corresponding to a predetermined time (for example, 126 corresponding to approximately 2 minutes and 30 seconds) (step S607). When the number of added blocks E₄(h) of four sources has not reached the number (126) (No in step S607), the above-described steps S301 to 305, S401 to S407, S501 and so on, and S601 to S607 are repeated. This concludes the details of the process of determining the employed block from the source sound signal S4 performed by the masker sound signal generating apparatus 12.

(A Process of Generating Masker Sound Signal)

FIG. 16 is a flowchart illustrating details of a process of generating the masker sound signal by the masker sound signal generating apparatus 12 (step S011 of FIG. 4). When the number of added blocks E₄(h) of four sources generated by the adding portion 127 has reached the predetermined number (126) (Yes in step S607), the reverse processing portion 128 performs the reverse process on each of these added blocks E₄(h) of four sources, namely, the added blocks E₄(1) to E₄(126) (step S701).

Subsequently, the frame coupling portion 129 arranges in the time axis direction the added blocks E₄(1) to E₄(126) on which the reverse process has been performed, and couples them while providing an overlapping section of 21 ms between adjacent added blocks E₄(h), thereby generating the masker sound signal (step S702). The frame coupling portion 129 writes the generated masker sound signal in the storage 120. This concludes the details of the process of generating the masker sound signal performed by the masker sound signal generating apparatus 12.

The masker sound signal generated by the masker sound signal generating apparatus 12 as described above is a sound signal obtained by combining the blocks sequentially determined from the respective source sound signals S1 to S4 based on the above-described performance index value so that the performance of masking the model sound corresponding to the target sound becomes high in any band of the frequency bands A(1) to A(19), that is, the blocks having a high probability that the degree of their power to be lower than the power of the model sound is small. Therefore, the masker sound signal generated by the masker sound signal generating apparatus 12 is a masker sound signal having a low probability of generating the gap period with respect to the target sound in any period and in any frequency band as compared to, for example, the sound signal obtained by combining blocks randomly determined from the source sound signal.

Further, the masker sound signal generating apparatus 12 selects the eight consecutive frames from the source sound signal S in generation of the masker sound signal as one block to use them. The time length of this one block is 1213 ms, which is sufficiently longer than an average time length of syllables in a voice at an ordinary speech rate. Therefore, the masker sound signal generated by the masker sound signal generating apparatus 12 is a masker sound signal which does not cause an unpleasant feeling of being heard as a voice at high speech rate, as caused to a listener by a masker sound signal generated by dividing the source sound signal into segments approximately equal to or shorter than the time lengths of syllables at an ordinary speech rate and coupling them in a replaced order.

The masker sound signal generated by the masker sound signal generating apparatus 12 is written in the storage 111 (for example, ROM 102) of the masker sound emitting apparatus 11 as already described, read by the sound emitting portion 112 from the storage 111, and used for emitting the masker sound to the sound space SP.

### Second Embodiment

A masker sound emitting apparatus 21 according to a second embodiment of the present invention will be described below. The masker sound emitting apparatus 21 according to the second embodiment has many points in common to the masker sound signal generating apparatus 12 according to the first embodiment. Therefore, differences of the masker sound emitting apparatus 21 from the masker sound signal generating apparatus 12 will be described mainly below. Further, for components provided in the masker sound emitting apparatus 21 in common to the masker sound signal generating apparatus 12, the same reference numerals as those used in the description of the first embodiment are used.

FIG. 17 is a diagram schematically illustrating a situation in which the masker sound emitting apparatus 21 is used. The masker sound emitting apparatus 21 emits a masker sound to the sound space SP, so as to mask, for example, a conversation between a person A and a person B in FIG. 17. Further, to the masker sound emitting apparatus 21, a microphone 22 as a sound pickup device disposed in the sound space SP where the masker sound is emitted is connected wirelessly or via wire.

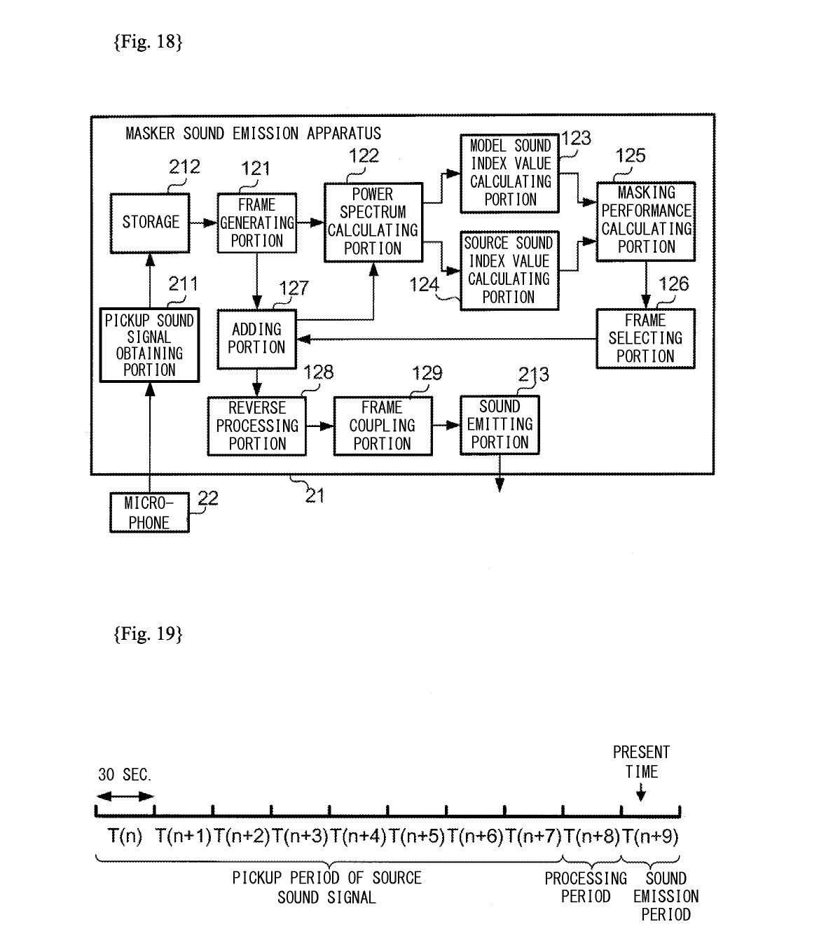

FIG. 18 is a diagram schematically illustrating a functional configuration of the masker sound emitting apparatus 21. The masker sound emitting apparatus 21 has a frame generating portion 121, a power spectrum calculating portion 122, a model sound index value calculating portion 123, a source sound index value calculating portion 124, a masking performance calculating portion 125, a frame selecting portion 126, an adding portion 127, a reverse processing portion 128, and a frame coupling portion 129 as functional components provided in common to the masker sound signal generating apparatus 12 of the first embodiment. Hereinafter, the above frame generating portion 121 to frame coupling portion 129 will generally be referred to as a masker sound signal generating portion 210.

Further, the masker sound emitting apparatus 21 has a pickup sound signal obtaining portion 211 configured to receive from the microphone 22 a pickup sound signal representing a sound picked up by the microphone 22, a storage 212 configured to sequentially store the pickup sound signal which the pickup sound signal obtaining portion 211 receives from the microphone 22 and sequentially store a masker sound signal generated by the masker sound signal generating portion 210, and a sound emitting portion 213 configured to emit the masker sound according to the masker sound signal stored in the storage 212.

The masker sound signal generating portion 210 uses the pickup sound signal for a predetermined time (for example, four minutes) in the past stored in the storage 212 as the model sound signal M, and uses the pickup sound signal also as the source sound signal S, so as to generate the masker sound signal. FIG. 19 is a diagram for explaining in which period the pickup sound signal used, when the masker sound signal generating portion 210 generates the masker sound signal, as the model sound signal M and the source sound signal S is stored. The rightward direction of FIG. 19 represents passage of time, and periods T(n) to T(n+9) each represent a period in a unit of 30 seconds (where n is an arbitrary natural number).

The masker sound signal generating portion 210 uses, in a period T(n+8) (where n is an arbitrary natural number), a pickup sound signal stored by the storage 212 in the periods T(n) to T(n+7) as the model sound signal M, a pickup sound signal stored in the periods T(n) to T(n+1) as the source sound signal S1, a pickup sound signal stored in the periods T(n+2) to T(n+3) as the source sound signal S2, a pickup sound signal stored in the periods T(n+4) to T(n+5) as the source sound signal S3, a pickup sound signal stored in the periods T(n+6) to T(n+7) as the source sound signal S4, so as to generate the masker sound signal. Hereinafter, the masker sound signal generated in the period T(n+8) by the masker sound signal generating portion 210 will be described as a masker sound signal Q(n). The storage 212 stores the masker sound signal Q(n) generated by the masker sound signal generating portion 210 in the period T(n+8). The sound emitting portion 213 reads the masker sound signal Q(n) from the storage 212, and emits the sound represented by the read masker sound signal Q(n) as the masker sound in the period T(n+9).

Thus, the masker sound emitting apparatus 21 generates the masker sound signal by using the pickup sound signal for four minutes representing a conversation made by speakers in the period from the present to the previous five minutes in the sound space SP, as the model sound signal M. Therefore, when a speaker in the sound space SP does not change in the period of about five minutes in the past, the target sound and the model sound will be a voice of the same speaker.

When the target sound and the model sound are voices of the same speaker, the correlation of characteristics related to power of the target sound and the model sound is high as compared to the case where the target sound and the model sound are voices of different speakers. Therefore, the masker sound signal generated by the masker sound emitting apparatus 21 is a masker sound signal with which a sound pressure level required for obtaining a nearly equal masking effect is still lower as compared to the masker sound signal generated by using the voice of a speaker different from the target sound as the model sound.

Further, the masker sound emitting apparatus 21 generates the masker sound signal by using the pickup sound signal for four minutes representing a conversation made by speakers in the period from the present to the previous five minutes in the sound space SP, as the source sound signal S. Therefore, when a speaker in the sound space SP does not change in the period of about five minutes in the past, the target sound and the source sound will be voices of the same speaker.

When the target sound and the model sound are voices of the same speaker, the correlation of characteristics related to power of the target sound and the model sound is high as compared to the case where the target sound and the model sound are voices of different speakers. Therefore, the masker sound signal generated by the masker sound emitting apparatus 21 is a masker sound signal with which a sound pressure level required for obtaining a nearly equal masking effect is still lower as compared to the masker sound signal generated by using the voice of a speaker different from the target sound as the model sound.

As described above, the masker sound provided by the masker sound emitting apparatus 21 is generated by using, as the model sound signal and the source sound signal, the pickup sound signal having a high probability of representing the voice of the speaker which is the same as that of the target sound, and thus is a masker sound for which the sound pressure level required for obtaining a nearly equal masking effect is still smaller. Further, the masker sound provided by the masker sound emitting apparatus 21 has a low probability of generating the gap period in all the frequency bands similarly to the masker sound represented by the masker sound signal generated by the masker sound signal generating apparatus 12 of the first embodiment, and does not cause an unpleasant feeling of being heard as a voice at high speech rate.

### Third Embodiment

A masker sound signal generating apparatus 32 according to a third embodiment of the present invention will be described below. The masker sound signal generating apparatus 32 according to the third embodiment has many points in common to the masker sound emitting apparatus 21 according to the second embodiment. Therefore, differences of the masker sound signal generating apparatus 32 from the masker sound emitting apparatus 21 will be described mainly below. Further, for components provided in the masker sound signal generating apparatus 32 in common to the masker sound emitting apparatus 21, the same reference numerals as those used in the description of the second embodiment are used.

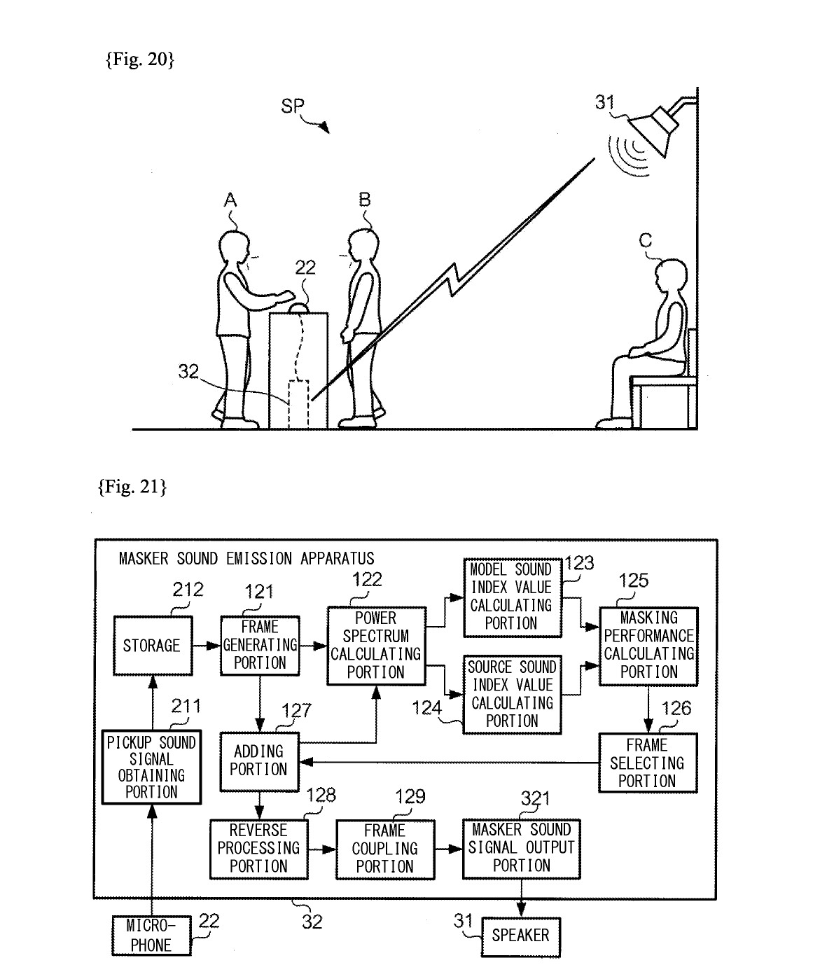

FIG. 20 is a diagram schematically illustrating a situation in which the masker sound signal generating apparatus 32 is used. To the masker sound signal generating apparatus 32, a microphone 22 as a sound pickup device disposed in the sound space SP where the masker sound is emitted is connected wirelessly or via wire. Further, to the masker sound signal generating apparatus 32, a speaker 31 as a sound emitting device emitting the masker sound to the sound space SP is connected wirelessly or via wire.

FIG. 21 is a diagram schematically illustrating a functional configuration of the masker sound signal generating apparatus 32. The masker sound signal generating apparatus 32 has a frame generating portion 121, a power spectrum calculating portion 122, a model sound index value calculating portion 123, a source sound index value calculating portion 124, a masking performance calculating portion 125, a frame selecting portion 126, an adding portion 127, a reverse processing portion 128, a frame coupling portion 129, a pickup sound signal obtaining portion 211, and a storage 212 as functional components provided in common to the masker sound emitting apparatus 21 of the second embodiment. Note that hereinafter, the above frame generating portion 121 to frame coupling portion 129 will generally be referred to as a masker sound signal generating portion 210, similarly to the case in the description of the second embodiment.

Further, the masker sound signal generating apparatus 32 does not have the sound emitting portion 213 provided in the masker sound emitting apparatus 21 of the second embodiment and has, instead of the sound emitting portion 213, a masker sound signal output portion 321 configured to output the masker sound signal generated by the masker sound signal generating portion 210 to the speaker 31.

The masker sound signal generating portion 210 of the masker sound signal generating apparatus 32 generates the masker sound signal by using the pickup sound signal inputted from the microphone 22 as the model sound signal M and the source sound signal S, and outputs the masker sound signal to the speaker 31 via the masker sound signal output portion 321. The speaker 31 emits the masker sound to the sound space SP according to the masker sound signal inputted from the masker sound signal generating apparatus 32.

By the masker sound signal generating apparatus 32 configured as above, similarly to the masker sound emitting apparatus 21, there is provided a masker sound having a low probability of generating the gap period in all the frequency bands, not causing an unpleasant feeling of being heard as a voice at high speech rate, and moreover not requiring the sound pressure level to be large compared to conventional arts and hardly impairing comfort of the listener.

### Modification Examples

The above-described embodiments can be modified in various ways within the technical idea of the present invention. Example of modifying them will be described below.

(1) Specific numeric values employed in the above-described embodiment are examples and can be changed in various ways. For example, the length of the frames is not limited to 170 ms. Further, the overlapping section provided when the frames are cut out from the model sound signal or the source sound signal, or when the added blocks of four sources are coupled, is not limited to 21 ms and may be any time length. Further, the number of source sound signals added when the masker sound signal is generated is not limited to four. Moreover, it may be configured to generate the masker sound signal by arranging and coupling the employed blocks determined from the source sound signals in the time axis direction without adding them. Further, the number of frequency bands is not limited to 19. Moreover, the number of frequency bands may be one. Further, the bandwidth of the frequency bands is not limited to ⅓ octave bandwidth. Further, the number of frames forming the candidate block, the employed block and the added block is not limited to eight. Moreover, the frame forming these blocks may be one frame. That is, a frame may be used as it is as a block. Further, the length of the model sound signal is not limited to four minutes. Further, the number of source sound signals is not limited to four, and the length of each source sound signal is not limited to one minute.

(2) In the above-described embodiment, the masker sound signal generating apparatus 12, the masker sound emitting apparatus 21 or the masker sound signal generating apparatus 32 is configured to use the same sound signal for both the model sound signal and the source sound signal in generation of the masker sound signal. Instead of this, the masker sound signal generating apparatus 12, the masker sound emitting apparatus 21 or the masker sound signal generating apparatus 32 may be configured to use as the source sound signal a sound signal different from a sound signal used for the model sound signal.

(3) In the second embodiment and the third embodiment described above, the masker sound emitting apparatus 21 or the masker sound signal generating apparatus 32 is configured to use the pickup sound signal for both the model sound signal and the source sound signal in generation of the masker sound signal. Instead of this, the masker sound emitting apparatus 21 or the masker sound signal generating apparatus 32 may be configured to use the pickup sound signal for the model sound signal and use a sound signal stored in the storage 212 in advance (sound signal different from the pickup sound signal) for the source sound signal. Further, the masker sound emitting apparatus 21 or the masker sound signal generating apparatus 32 may be configured to use the pickup sound signal for the source sound signal and use a sound signal stored in the storage 212 in advance (sound signal different from the pickup sound signal) for the model sound signal.

(4) In the above-described modification example (3), when the masker sound emitting apparatus 21 or the masker sound signal generating apparatus 32 is configured to use the pickup sound signal for the model sound signal and use a sound signal stored in the storage 212 in advance (sound signal different from the pickup sound signal) for the source sound signal, these apparatuses may be configured to have a portion for selecting one or more source sound signals based on characteristics related to power of the pickup sound signal from among plural source sound signals stored in the storage 212 in advance and generate the masker sound signal by using the one or more source sound signals selected by the portion.

(5) In the above-described embodiments, the masker sound signal generating apparatus 12, the masker sound emitting apparatus 21 or the masker sound signal generating apparatus 32 is configured to select eight consecutive frames so as not to include any frame to which the employed mark is added when the candidate block is formed from frames of the source sound signal. Instead of this, the masker sound signal generating apparatus 12, the masker sound emitting apparatus 21 or the masker sound signal generating apparatus 32 may be configured to select eight consecutive frames while allowing containing frames to which the employed mark is added as long as they are not more than a predetermined upper limit number.

(6) In the above-described embodiments, the masker sound signal generating apparatus 12, the masker sound emitting apparatus 21 or the masker sound signal generating apparatus 32 is configured to sequentially retrieve eight consecutive frames from the source sound signal as candidate blocks while shifting the frames one by one from the head in generation of the candidate blocks. The method of selecting the frames forming the candidate blocks from frames of the source sound signal is not limited to this. For example, the masker sound signal generating apparatus 12, the masker sound emitting apparatus 21 or the masker sound signal generating apparatus 32 may be configured to sequentially retrieve eight consecutive frames from the source sound signal as candidate blocks while shifting the frames by a predetermined number of two or more from the head. Further, the masker sound signal generating apparatus 12, the masker sound emitting apparatus 21 or the masker sound signal generating apparatus 32 may be configured to retrieve eight consecutive frames as candidate blocks randomly from frames of the source sound signal.

(7) In the above-described embodiments, the masker sound signal generating apparatus 12, the masker sound emitting apparatus 21 or the masker sound signal generating apparatus 32 is configured to perform the reverse process on the added block of four sources in generation of the masker sound signal, but may also be configured not to perform the reverse process.

(8) In the above-described embodiments, the masker sound signal generating apparatus 12, the masker sound emitting apparatus 21 or the masker sound signal generating apparatus 32 is configured to first determine the employed block from the source sound signal S1, determine the employed block from the source sound signal S2 based on the performance index value calculated by using the source sound index value of the employed block from the source sound signal S1, determine the employed block from the source sound signal S3 based on the performance index value calculated by using the source sound index value of the added block of two sources, and determine the employed block from the source sound signal S4 based on the performance index value calculated by using the source sound index value of the added block of three sources. The process of determining the employed block and the order of processes of the addition performed by the masker sound signal generating apparatus 12, the masker sound emitting apparatus 21 or the masker sound signal generating apparatus 32 is not limited to this.

For example, the masker sound signal generating apparatus 12, the masker sound emitting apparatus 21 or the masker sound signal generating apparatus 32 may be configured to generate numerous added blocks of four sources by adding four frames selected randomly or in accordance with predetermined rules from each of the source sound signals S1 to S4, and determine the added block of four sources to be used in generation of the masker sound signal based on the performance index value calculated for each of the numerous added blocks of four sources.

Further, as long as the calculation load is within an allowable range, the masker sound signal generating apparatus 12, the masker sound emitting apparatus 21 or the masker sound signal generating apparatus 32 may be configured to calculate a performance evaluation value of the added block of four sources for all combinations of candidate blocks arbitrarily retrieved from each of the source sound signals S1 to S4, and determine the added blocks to be employed according to the calculated performance evaluation value.

(9) In the above-described embodiments, the masker sound signal generating apparatus 12, the masker sound emitting apparatus 21 or the masker sound signal generating apparatus 32 is configured to first generate plural added blocks of four sources and then couple the generated plural added blocks of four sources in generation of the masker sound signal. The order of the adding process and the coupling process of employed blocks performed by the masker sound signal generating apparatus 12, the masker sound emitting apparatus 21 or the masker sound signal generating apparatus 32 is not limited to this. For example, the masker sound signal generating apparatus 12, the masker sound emitting apparatus 21 or the masker sound signal generating apparatus 32 may be configured to first couple, in every source sound signal, employed blocks determined for each of the source sound signals S1 to S4 to generate four sound signals, and add these four sound signals, so as to generate the masker sound signal.

(10) In the above-described embodiments, the masker sound signal generating apparatus 12, the masker sound emitting apparatus 21 or the masker sound signal generating apparatus 32 is configured to calculate the index value Xₘ(i,f), the source sound index value and the performance index value used for calculating the model sound index value for each of 19 frequency bands A(f) obtained by dividing the frequency band of voice (for example, 100 Hz to 6300 Hz) by a ⅓ octave bandwidth. The points that the number of frequency bands for which the masker sound signal generating apparatus 12, the masker sound emitting apparatus 21 or the masker sound signal generating apparatus 32 calculates these index values is not limited to 19, and that the bandwidth of the frequency bands is not limited to the ⅓ octave bandwidth, are as already described. Moreover, when there are plural frequency bands, their bandwidths may be different from one another. Further, the masker sound signal generating apparatus 12, the masker sound emitting apparatus 21 or the masker sound signal generating apparatus 32 may be configured to calculate the index value Xₘ(i,f) used for calculating the model sound index value, the source sound index value and the performance index value for each of one or more frequency bands covering only a portion of the frequency band of voice.

(11) In the above-described first embodiment, the masker sound signal generating apparatus 12 is configured to add blocks formed of frames retrieved respectively from the four source sound signals representing voices of four different persons when the masker sound signal is generated. The frames forming blocks to be added when the masker sound signal generating apparatus 12 generates the masker sound signal need not represent voices of different persons respectively. Specifically, two or more blocks among the blocks added by the masker sound signal generating apparatus 12 may be blocks formed of frames retrieved from the source sound signal representing the voice of the same person.

(12) In the above-described first embodiment, the source sound signals used for generating the masker sound signal by the masker sound signal generating apparatus 12 are four audio signals in which combinations of two attributes, high or low of voice and gender, are different. The plural source sound signals used for generating the masker sound signal by the masker sound signal generating apparatus 12 are not limited to the audio signals focusing on the attributes of high or low of voice and gender, and may be different audio signals focusing on attributes other than the high or low of voice and gender, for example, language, age group, and speech rate.

(13) In the above-described second embodiment and third embodiment, the masker sound emitting apparatus 21 or the masker sound signal generating apparatus 32 adds the blocks formed of frames retrieved from the pickup sound signal when the masker sound signal is generated. The blocks to be added when the masker sound signal is generated by the masker sound emitting apparatus 21 or the masker sound signal generating apparatus 32 need not entirely be formed of the frames retrieved from the pickup sound signal. That is, part of the blocks to be added by the masker sound emitting apparatus 21 or the masker sound signal generating apparatus 32 may be a block formed of frames retrieved from a sound signal different from the pickup sound signal, such as the source sound signal stored in the storage 212 in advance.

(14) In the above-described embodiments, the masker sound signal generating apparatus 12, the masker sound emitting apparatus 21 or the masker sound signal generating apparatus 32 uses an audio signal representing a human voice as the source sound signal. The masker sound signal generating apparatus 12, the masker sound emitting apparatus 21 or the masker sound signal generating apparatus 32 may be configured to use as the source sound signal a sound signal representing a sound other than a human voice, such as a sound of babbling stream, in addition to the audio signal representing a human voice as the source sound signal.

(15) In the above-described embodiments, the masker sound signal generating apparatus 12, the masker sound emitting apparatus 21 or the masker sound signal generating apparatus 32 may be configured to have an adjusting portion configured to increase or decrease the sound volume level of a candidate block retrieved from the source sound signal, and generate candidate blocks at different sound volume levels exhibiting the same waveform. For example, when a candidate block formed of frames retrieved from the source sound signal is used as an original candidate block, the adjusting portion may be configured to generate a new candidate block increased in sound volume level by, for example, 20% relative to the original candidate block and a new candidate block decreased in sound volume level by 20%, and use these candidate blocks increased or decreased in sound volume level as choices for employed blocks in addition to the original candidate block.

In this modification example, the masker sound signal generating apparatus 12, the masker sound emitting apparatus 21 or the masker sound signal generating apparatus 32 may calculate the performance index value related to each of the original candidate block and the candidate blocks increased or decreased in sound volume level in accordance with following formula 6 to formula 9 instead of the above-described formula 2 to formula 4, respectively.

$$\begin{matrix}\{ Math . 6 \} & \\ {c}_{1} ( k ) = {\sum }_{f = 1}^{19} {\sum }_{j = 1}^{8} [ 10 {log}_{10} P ( f ) - 10 {log}_{10} s \cdot {X}_{1} ( k + j - 1 , f ) ] & ( Formula 6 ) \\ \{ Math . 7 \} & \\ {c}_{2} ( k ) = {\sum }_{f = 1}^{19} {\sum }_{j = 1}^{8} \{ 10 {log}_{10} P ( f ) - 10 {log}_{10} [ {Y}_{1} ( j , f ) + s \cdot {X}_{2} ( k + j - 1 , f ) ] \} & ( Formula 7 ) \\ \{ Math . 8 \} & \\ {c}_{3} ( k ) = {\sum }_{f = 1}^{19} {\sum }_{j = 1}^{8} \{ 10 {log}_{10} P ( f ) - 10 {log}_{10} [ {Y}_{2} ( j , f ) + s \cdot {X}_{3} ( k + j - 1 , f ) ] \} & ( Formula 8 ) \\ \{ Math . 9 \} & \\ {c}_{4} ( k ) = {\sum }_{f = 1}^{19} {\sum }_{j = 1}^{8} \{ 10 {log}_{10} P ( f ) - 10 {log}_{10} [ {Y}_{3} ( j , f ) + s \cdot {X}_{4} ( k + j - 1 , f ) ] \} & ( Formula 9 )\end{matrix}$$

Here, s is a coefficient indicating a rate of change of the sound volume level. When calculating the performance index value in accordance with the above formula 6 to formula 9, the masker sound signal generating apparatus 12, the masker sound emitting apparatus 21 or the masker sound signal generating apparatus 32 calculates plural performance index values by using different values of the coefficient s (for example, “1.2”, “1.0”, and “0.8”) for the same candidate block. For example, the performance index value calculated with the coefficient s=1.2 is the performance index value of the candidate block increased in sound volume level by 20% relative to the original candidate block, the performance index value calculated with the coefficient s=1.0 is the performance index value of the original candidate block, and the performance index value calculated with the coefficient s=0.8 is the performance index value of the candidate block decreased in sound volume level by 20% relative to the original candidate block. In accordance with the formula 6 to formula 9, the performance index value relative to the candidate block after the sound volume level is increased or decreased is calculated without actually increasing or decreasing the sound volume level with respect to the original candidate block. The masker sound signal generating apparatus 12, the masker sound emitting apparatus 21 or the masker sound signal generating apparatus 32 identifies the performance index value with the minimum value from among the performance index values calculated in accordance with the formula 6 to formula 9, and then increases or decreases the sound volume level of the original candidate block corresponding to the identified performance index value by the adjusting portion in accordance with the coefficient s used for calculating the identified performance index values, so as to generate the employed block. Therefore, the adjusting portion just have to increase or decrease the sound volume level of the original candidate block as necessary when the employed block is generated, and need not increase or decrease a sound volume level for all the candidate blocks.

As described above, when those obtained by increasing or decreasing the sound volume level of the original candidate block is used as a new candidate block, the method of calculation thereof is not limited as long as the performance index value related to the candidate block obtained by increasing or decreasing the sound volume level is calculated.

Further, the candidate block as a target of increasing or decreasing the sound volume level by the adjusting portion is not limited to a block retrieved from the source sound signal S, and may be an added block in which plural candidate blocks are added. Further, the adding portion 127 may be provided integrally with the adjusting portion. That is, it may be configured to increase or decrease the sound volume level of the block as the target of addition when the plural blocks are added. Further, in the above-described first embodiment, it may be configured to store plural source sound signals exhibiting the same waveform but having different sound volume levels from each other in advance in the storage 120 of the masker sound signal generating apparatus 12, and use them for generating the masker sound signal.

(16) In the above-described embodiments, the masker sound signal generating apparatus 12, the masker sound emitting apparatus 21 or the masker sound signal generating apparatus 32 calculates the performance index value in accordance with the calculation formulas represented by the above-described formula 2 to formula 5, but these calculation formulas are merely examples and other calculation formulas may be used. Examples of calculation formulas which can be replaced with the formula 2 to formula 6 are presented below.

For example, as replacements of the formula 3 to formula 5, following formula 10 to formula 12 are employable. Here, max(A,B) is a function representing the maximum value in A and B.

$$\begin{matrix}\{ Math . 10 \} & \\ {c}_{2} ( k ) = {\sum }_{f = 1}^{19} {\sum }_{j = 1}^{8} \{ 10 {log}_{10} P ( f ) - 10 {log}_{10} max [ {Y}_{1} ( j , f ) , {X}_{2} ( k + j - 1 , f ) ] \} & ( Formula 10 ) \\ \{ Math . 11 \} & \\ {c}_{3} ( k ) = {\sum }_{f = 1}^{19} {\sum }_{j = 1}^{8} \{ 10 {log}_{10} P ( f ) - 10 {log}_{10} max [ {Y}_{2} ( j , f ) , {X}_{3} ( k + j - 1 , f ) ] \} & ( Formula 11 ) \\ \{ Math . 12 \} & \\ {c}_{4} ( k ) = {\sum }_{f = 1}^{19} {\sum }_{j = 1}^{8} \{ 10 {log}_{10} P ( f ) - 10 {log}_{10} max [ {Y}_{3} ( j , f ) , {X}_{4} ( k + j - 1 , f ) ] \} & ( Formula 12 )\end{matrix}$$

The above formula 10 to formula 12 are calculation formulas such that, for each frequency band, larger one of the source sound index value of the added block obtained by adding already determined employed block and the source sound index value of the candidate block is reflected on calculation of the performance index value, and thereby the source sound index value of the candidate block is not reflected on the performance index value for a frequency band for which the candidate block does not improve frequency characteristics of the added block.

Further, following formula 13 to formula 16 are employable as replacements of the formula 2 to formula 5.

$$\begin{matrix}\{ Math . 13 \} & \\ {c}_{1} ( k ) = {\sum }_{f = 1}^{19} {\sum }_{j = 1}^{8} [ P ( f ) - {X}_{1} ( k + j - 1 , f ) ] & ( Formula 13 ) \\ \{ Math . 14 \} & \\ {c}_{2} ( k ) = {\sum }_{f = 1}^{19} {\sum }_{j = 1}^{8} \{ P ( f ) - [ {Y}_{1} ( j , f ) + {X}_{2} ( k + j - 1 , f ) ] \} & ( Formula 14 ) \\ \{ Math . 15 \} & \\ {c}_{3} ( k ) = {\sum }_{f = 1}^{19} {\sum }_{j = 1}^{8} \{ P ( f ) - [ {Y}_{2} ( j , f ) + {X}_{3} ( k + j - 1 , f ) ] \} & ( Formula 15 ) \\ \{ Math . 16 \} & \\ {c}_{4} ( k ) = {\sum }_{f = 1}^{19} {\sum }_{j = 1}^{8} \{ P ( f ) - [ {Y}_{3} ( j , f ) + {X}_{4} ( k + j - 1 , f ) ] \} & ( Formula 16 )\end{matrix}$$

The above formula 13 to formula 16 are calculation formulas for calculating the performance index value by using a power spectrum not transformed into a logarithm (what is called an energy value) instead of the power spectrum transformed into a logarithm (what is called a dB value).

Further, following formula 17 to formula 20 are employable as replacements of the formula 2 to formula 5. Here, min(A,B) is a function representing the minimum value in A and B.

$$\begin{matrix}\{ Math . 17 \} & \\ {c}_{1} ( k ) = {\sum }_{f = 1}^{19} {\sum }_{j = 1}^{8} min [ 20 , 10 {log}_{10} P ( f ) - 10 {log}_{10} {X}_{1} ( k + j - 1 , f ) ] & ( Formula 17 ) \\ \{ Math . 18 \} & \\ {c}_{2} ( k ) = {\sum }_{f = 1}^{19} {\sum }_{j = 1}^{8} min \{ 20 , 10 {log}_{10} P ( f ) - 10 {log}_{10} [ {Y}_{1} ( j , f ) + {X}_{2} ( k + j - 1 , f ) ] \} & ( Formula 18 ) \\ \{ Math . 19 \} & \\ {c}_{3} ( k ) = {\sum }_{f = 1}^{19} {\sum }_{j = 1}^{8} min \{ 20 , 10 {log}_{10} P ( f ) - 10 {log}_{10} [ {Y}_{2} ( j , f ) + {X}_{3} ( k + j - 1 , f ) ] \} & ( Formula 19 ) \\ \{ Math . 20 \} & \\ {c}_{4} ( k ) = {\sum }_{f = 1}^{19} {\sum }_{j = 1}^{8} min \{ 20 , 10 {log}_{10} P ( f ) - 10 {log}_{10} [ {Y}_{3} ( j , f ) + {X}_{4} ( k + j - 1 , f ) ] \} & ( Formula 20 )\end{matrix}$$

The above formula 17 to formula 20 are calculation formulas such that a threshold (20 in the above formulas) is provided in calculation of an index value of performance for masking the model sound of the candidate block related to each frequency band, and the performance index value is calculated by summing index values related to each frequency band which are calculated so as not to exceed this threshold. These calculation formulas, as will be described below, avoid a disadvantage that there may occur cases where the index value in a certain frequency band cancels out the index value in another frequency band, and the performance index value calculated by summing the index values of respective frequency bands does not correctly reflect the masking performance of the candidate block.

For example, it is assumed that when the employed block is determined from the candidate block of the source sound signal S1, the source sound index value of the first candidate block indicates power of −50 dB relative to the model sound index value for the frequency band A(1), and indicates power of −5 dB relative to the model sound index value for the frequency band A(2). Further, it is assumed that the source sound index value of the second candidate block indicates power of −30 dB relative to the model sound index value for the frequency band A(1), and indicates power of −10 dB relative to the model sound index value for the frequency band A(2). Then, it is assumed that the source sound index values of the first candidate block and the second candidate block both indicate the same power for the frequency bands A(3) to A(19).

In this case, for the frequency band A(l), the first candidate block and the second candidate block both have small power, and consequently there is hardly any difference in masking performance. On the other hand, for the frequency band A(2), the first candidate block is smaller than the second candidate block in degree of the source sound index value to be lower than the model sound index value, and thus the masking performance of the first candidate block is better. Further, for the frequency bands A(3) to A(19), there is no difference in source sound index values of the first candidate block and the second candidate block, and thus there is no difference in masking performance between the first candidate block and the second candidate block for these frequencies. Therefore, the masking performance related to all the frequency bands is better in the first candidate block than in the second candidate block.

However, in the cases in accordance with the formula 2, the performance evaluation value calculated for the first candidate block becomes larger than the performance evaluation value calculated for the second candidate block, and thus is evaluated to have a low masking performance. This is because the source sound index value of the first candidate block for the frequency band A(1) is −30 dB relative to the source sound index value of the second candidate block, the source sound index value of the first candidate block for the frequency band A(2) is +5 dB relative to the source sound index value of the second candidate block, and the evaluation in the frequency band A(l) where there is hardly any difference in masking performance cancels out the evaluation in the frequency band A(2) where there is a large difference in masking performance.

In order to avoid the above-described disadvantage, the formula 17 to formula 20 are proposed. Specifically, in the formula 17 for example, in both the first candidate block and the second candidate block, the log-converted value of the source sound index value is still lower than the value at −20 dB relative to the log-converted value of the model sound index value for the frequency band A(1), and their difference is larger than 20 dB as the threshold. Thus, not the value of the difference itself but the 20 dB as the threshold (constant value) is reflected on the performance index value. Consequently, the performance index value of the first candidate block becomes smaller than the performance index value of the second candidate block, and the first candidate block is correctly evaluated as exhibiting a higher masking performance than the second candidate block. This is because contribution to the masking performance in the frequency band A(l) is equal in any of the candidate blocks, and a contribution to the masking performance in the frequency band A(2) is evaluated to be larger in the first candidate block than in the second candidate block.

The above modification example is an example in which the upper threshold (20 in the above formulas) is provided in calculation of the index value of performance of masking the model sound of the candidate block for each frequency band. Instead of this or in addition thereto, it may be configured to provide a lower threshold. Following formulas 21 to 24 are examples of formulas which are employable as replacements of the formula 2 to formula 5 when both the upper and lower thresholds are provided. Here, min(A,B) is a function representing the minimum value in A and B, and max(A,B) is a function representing the maximum value in A and B.

$$\begin{matrix}\{ Math . 21 \} & \\ {c}_{1} ( k ) = {\sum }_{f = 1}^{19} {\sum }_{j = 1}^{8} max \{ - 10 , min [ 20 , 10 {log}_{10} P ( f ) - 10 {log}_{10} {X}_{1} ( k + j - 1 , f ) ] \} & ( Formula 21 ) \\ \{ Math . 22 \} & \\ {c}_{2} ( k ) = {\sum }_{f = 1}^{19} {\sum }_{j = 1}^{8} max \{ - 10 , min \{ 20 , 10 {log}_{10} P ( f ) - 10 {log}_{10} [ {Y}_{1} ( j , f ) + {X}_{2} ( k + j - 1 , f ) \} \} & ( Formula 22 ) \\ \{ Math . 23 \} & \\ {c}_{3} ( k ) = {\sum }_{f = 1}^{19} {\sum }_{j = 1}^{8} max \{ - 10 , min \{ 20 , 10 {log}_{10} P ( f ) - 10 {log}_{10} [ {Y}_{2} ( j , f ) + {X}_{3} ( k + j - 1 , f ) ] \} \} & ( Formula 23 ) \\ \{ Math . 24 \} & \\ {c}_{4} ( k ) = {\sum }_{f = 1}^{19} {\sum }_{j = 1}^{8} max \{ - 10 , min \{ 20 , 10 {log}_{10} P ( f ) - 10 {log}_{10} [ {Y}_{3} ( j , f ) + {X}_{4} ( k + j - 1 , f ) \} \} & ( Formula 24 )\end{matrix}$$

In the formula 21 to formula 24, in addition to the upper threshold (20 in the above formulas), a lower threshold (−10 in the above formulas) is provided. The index values of performance of masking the model sound of the candidate block for the respective frequency bands are calculated so as not to downwardly exceed (that is, not to fall below) the lower threshold, and they are summed to calculate the performance index value for all the frequency bands.

For example, it is assumed that when the employed block for adding to the added block of three sources is determined from the candidate block of the source sound signal S1, the total value of the source sound index value of the added block of three sources and the source sound index value of the first candidate block indicates power of 15 dB relative to the model sound index value for the frequency band A(1), and indicates power of 5 dB relative to the model sound index value for the frequency band A(2). Further, it is assumed that the total value of the source sound index value of the added block of three sources and the source sound index value of the second candidate block indicates power of 30 dB relative to the model sound index value for the frequency band A(1), and indicates power of −5 dB relative to the model sound index value for the frequency band A(2). Then, it is assumed that the source sound index values of the first candidate block and the second candidate block have the same power for the frequency bands A(3) to A(19). That is, it is assumed that there is no difference for each of the frequency bands A(3) to A(19) between the total value of the source sound index value of the added block of three sources and the source sound index value of the first candidate block and the total value of the source sound index value of the added block of three sources and the source sound index value of the second candidate block.

In this case, for the frequency band A(1), one obtained by adding the first candidate block to the added block of three sources and one obtained by adding the second candidate block to the added block of three sources can both be assumed as sufficiently exceeding power of the model sound, and thus there is hardly any difference in masking performance. On the other hand, for the frequency band A(2), one obtained by adding the first candidate block to the added block of three sources is better in masking performance than one obtained by adding the second candidate block to the added block of three sources. Further, for each of the frequency bands A(3) to A(19), there is no difference in masking performance between the first candidate block and the second candidate block. Therefore, by determining the first candidate block as the employed block, it is possible to generate the added block of four sources exhibiting a better masking performance than by determining the second candidate block as the employed block.

In this case, unless the lower threshold (−10 in the above formulas) is provided, the evaluation in the frequency band A(1) where there is hardly any difference in masking performance cancels out the evaluation in the frequency band A(2) where there is a large difference in masking performance. Thus, the performance evaluation value calculated for the first candidate block becomes larger than the performance evaluation value calculated for the second candidate block, and is evaluated to have a low masking performance. By providing the lower threshold, such a disadvantage is avoided.

Note that in the above-described modification examples, the upper or lower threshold is the same value in all the frequency bands, but these thresholds may be different in every frequency band.

(17) In the above-described embodiments, when calculating the model sound index value and the source sound index value, the masker sound signal generating apparatus 12, the masker sound emitting apparatus 21 or the masker sound signal generating apparatus 32 calculates an arithmetic mean value of power spectra of respective frequency bands of a frame as an index value indicating a characteristic related to power of a sound signal represented by the frame. The index value indicating a characteristic related to power of each frequency band of the frame is not limited to the arithmetic mean value of power spectra, and the masker sound signal generating apparatus 12, the masker sound emitting apparatus 21 or the masker sound signal generating apparatus 32 may be configured to calculate another value, for example, a geometric mean value of power spectrum, a maximum value of power spectrum, or the like as the index value indicating a characteristic related to power of each frequency band of the frame.

Moreover, as the index value of the sound signal used by the masker sound signal generating apparatus 12, the masker sound emitting apparatus 21 or the masker sound signal generating apparatus 32 for calculating the model sound index value and the source sound index value, various ones may be employed as long as they are an index value indicating the magnitude of a sound signal. For example, a sound pressure (Pa) and a sound pressure level (dB), acoustic energy (acoustic intensity (W/m²)) or the like indicating the intensity of sound represented by the model sound signal or the source sound signal, characteristics to which a frequency weight characteristic indicating the magnitude of sound represented by the model sound signal or the source sound signal is added (for example, A characteristic sound pressure level (dB)), or the like may be used for calculating the model sound index value and the source sound index value. In this case, the model sound index value and the source sound index value are not limited to the index value indicating power of a sound signal, and are considered as an index value widely indicating the magnitude of a sound signal.

(18) In the above-described first embodiment, the masker sound signal generating apparatus 12 generates the masker sound signal by using the model sound signal and the source sound signal stored in advance in the storage 120. The method of obtaining the model sound signal and the source sound signal by the masker sound signal generating apparatus 12 is not limited to this, and for example, the masker sound signal generating apparatus 12 may be configured to have a receiving portion configured to receive a sound signal from an outside device via a network such as the Internet, and obtain at least one of the model sound signal and the source sound signal from the outside device by the receiving portion.

(19) In the above-described first embodiment, the masker sound signal generating apparatus 12 is configured to be stored in advance in the ROM 102 or the like of the masker sound emitting apparatus 11, and read from the ROM 102 or the like and used when a masker sound is emitted. Instead of this, the masker sound signal generating apparatus 12 and the masker sound emitting apparatus 11 may be configured to be capable of communicating data with each other via a network or the like, and configured such that the masker sound emitting apparatus 11 receives the masker sound signal from the masker sound signal generating apparatus 12 and uses it when emitting the masker sound.

(20) In the above-described first embodiment, it may be configured such that at least one of the source sound signals S1 to S4 represents only a male voice and at least another one of the source sound signals S1 to S4 represents only a female voice, such that the source sound signals S1 and S2 represent only male voices and the source sound signals S3 and S4 represent only female voices, or the like. In this case, the masker sound signal to be generated by the masker sound signal generating apparatus 12 always includes male and female voices in all the time sections. Generally, a target sound produced by a female can easily be separated from a masker sound generated only from a male voice, and a target sound produced by a male can easily be separated from a masker sound generated only from a female voice. Since the masker sound signal generated by the masker sound signal generating apparatus 12 according to this modification example always includes male and female voices in all the time sections, it becomes a masker sound signal in which target sounds produced by either of a male and a female are difficult to be separated.

(21) In the above-described first embodiment, each of the source sound signals S1 to S4 may be a sound signal representing the voice of one speaker, or may be a sound signal simultaneously representing voices of plural speakers. When the source sound signals S1 to S4 are a sound signal simultaneously representing voices of plural speakers, the sound signal may be a sound signal obtained by picking up voices produced simultaneously by plural speakers in the same space, or a sound signal generated by adding sound signals obtained by picking up voices separately emitted independently by plural respective speakers.

(22) In the above-described embodiments, it is configured that the difference between the model sound index value and the source sound index value calculated for each of the plural frequency bands is simply summed when the performance index value is calculated. Instead of this, it may be configured to calculate the performance index value by summing the difference between the model sound index value and the source sound index value calculated for each of the plural frequency bands while weighting it with a predetermined weight. It is reported that contribution to clarity of voice differs depending on frequency bands, and thus for example in this modification example, it is conceivable to weight with a larger weight a frequency band in which the clarity of voice is high and which largely affects the masking performance. Consequently, the calculated performance index value will be one indicating the masking performance more accurately, and the masking performance of the masker sound signal generated in accordance with the performance index value becomes higher.

(23) In the above-described embodiments, the masker sound signal generating apparatus 12, the masker sound emitting apparatus 21 and the masker sound signal generating apparatus 32 are realized by a general computer executing processing in accordance with a program according to the embodiments, but these apparatuses may be realized as what are called dedicated apparatuses.

Note that the above-described embodiments and modification examples may be combined appropriately.

### REFERENCE SIGNS LIST

11 . . . masker sound emitting apparatus, 12 . . . masker sound signal generating apparatus, 21 . . . masker sound emitting apparatus, 22 . . . microphone, 31 . . . speaker, 32 . . . masker sound signal generating apparatus, 101 . . . CPU, 102 . . . ROM, 103 . . . RAM, 104 . . . D/A converter, 105 . . . amplifier, 106 . . . speaker, 111 . . . storage, 112 . . . sound emitting portion, 120 . . . storage, 121 . . . frame generating portion, 122 . . . power spectrum calculating portion, 123 . . . model sound index value calculating portion, 124 . . . source sound index value calculating portion, 125 . . . masking performance calculating portion, 126 . . . frame selecting portion, 127 . . . adding portion, 128 . . . reverse processing portion, 129 . . . frame coupling portion, 210 . . . masker sound signal generating portion, 211 . . . pickup sound signal obtaining portion, 212 . . . storage, 213 . . . sound emitting portion, 321 . . . masker sound signal output portion

1. An apparatus for generating a masker sound signal, comprising:
a model sound signal obtaining portion configured to obtain a model sound signal corresponding to a sound to be masked;
a model sound index value calculating portion configured to calculate an index value of magnitude of the model sound signal;
a source sound signal obtaining portion configured to obtain a source sound signal for generating a masker sound signal representing a sound which masks;
a source sound index value calculating portion configured to divide the source sound signal into plural frames having a predetermined time length and calculate an index value of magnitude of a sound signal in each of the plural frames;
a masking performance calculating portion configured to calculate, by using the index value calculated by the model sound index value calculating portion and the index value calculated by the source sound index value calculating portion, an index value of performance of masking by a sound represented by one or more frames of the source sound signal;
a frame selecting portion configured to select plural frames from among the plural frames of the source sound signal based on the index value calculated by the masking performance calculating portion; and
a frame coupling portion configured to couple the plural frames selected by the frame selecting portion on a time axis, to thereby generate the masker sound signal.

2. The apparatus for generating a masker sound signal according to claim 1,
wherein the model sound index value calculating portion divides the model sound signal into plural frames having a predetermined time length, calculates an index value of magnitude of a sound signal in each of the plural frames, and takes a maximum value among the calculated index values as the index value of magnitude of the model sound signal.

3. The apparatus for generating a masker sound signal according to claim 1,
wherein the model sound index value calculating portion calculates the index value of magnitude of the model sound signal for each frequency band of two or more frequency bands,
wherein the source sound index value calculating portion calculates the index value of magnitude of the sound signal in each of the plural frames for each frequency band of the two or more frequency bands, and
wherein the masking performance calculating portion calculates, for each frequency band of the two or more frequency bands, the index value of performance for the frequency band by using the index value calculated by the model sound index value calculating portion and the index value calculated by the source sound index value calculating portion.

4. The apparatus for generating a masker sound signal according to claim 3,
wherein the masking performance calculating portion calculates, for each frequency band of the two or more frequency bands, the index value of performance so as not to exceed a predetermined threshold.

5. The apparatus for generating a masker sound signal according to claim 1, comprising an adding portion configured to add the plural frames selected from among plural frames of the source sound signal to generate an added frame,
wherein the masking performance calculating portion calculates the index value of performance indicating a performance of masking by a sound represented by the added frame generated by the adding portion.

6. The apparatus for generating a masker sound signal according to claim 1, comprising an adjusting portion configured to increase or decrease a sound volume level of one or more frames among the plural frames of the source sound signal,
wherein the masking performance calculating portion calculates the index value of performance indicating a performance of masking by a sound represented by a frame whose sound volume level is increased or decreased by the adjusting portion.

7. The apparatus for generating a masker sound signal according to claim 1, comprising a sound emitting portion configured to emit a sound according to the masker sound signal generated by the frame coupling portion.

8. A method for generating a masker sound signal, comprising:
obtaining a model sound signal corresponding to a sound to be masked;
calculating an index value of magnitude of the model sound signal;
obtaining a source sound signal for generating a masker sound signal representing a sound which masks;
dividing the source sound signal into plural frames having a predetermined time length and calculating an index value of magnitude of a sound signal in each of the plural frames;
calculating, by using the index value of magnitude of the model sound signal and the index value of magnitude of a sound signal in each of the plural frames of the source sound signal, an index value of performance of masking by a sound represented by one or more frames of the source sound signal;
selecting plural frames from among the plural frames of the source sound signal based on the index value of performance; and
coupling the selected plural frames on a time axis, to thereby generate the masker sound signal.

9. An apparatus for emitting a masker sound signal, comprising a sound emitting portion configured to emit a sound according to the masker sound signal generated by the method for generating a masker sound signal according to claim 8.

10. A non-transitory machine-readable storage medium containing program instructions executable by a computer for generating a masker sound signal, the program instructions enabling the computer to perform:
obtaining a model sound signal corresponding to a sound to be masked;
calculating an index value of magnitude of the model sound signal;
obtaining a source sound signal for generating a masker sound signal representing a sound which masks;
dividing the source sound signal into plural frames having a predetermined time length and calculating an index value of magnitude of a sound signal in each of the plural frames;
calculating, by using the index value of magnitude of the model sound signal and the index value of magnitude of a sound signal in each of the plural frames of the source sound signal, an index value of performance of masking by a sound represented by one or more frames of the source sound signal;
selecting plural frames from among the plural frames of the source sound signal based on the index value of performance; and
coupling the selected plural frames on a time axis, to thereby generate the masker sound signal.
